(19) United States
(12) Patent Application Publication
(10) Pub. No.: US 2024/0356488 A1
(43) Pub. Date: Oct. 24, 2024

(54) SYSTEM AND METHOD FOR DETECTION OF SHADING AND SOILING ON SOLAR PANELS USING COMPUTER VISION

(71) Applicant: The AES Corporation, Arlington, VA (US)

(72) Inventors: Srikanth Tadepalli, Tempe, AZ (US); Sean Otto, Indianapolis, IN (US); Amy Lenneman, Lakewood, CO (US); Brittany Nixon, Denver, CO (US); Esteban Hincapie, Longmont, CO (US)

(73) Assignee: The AES Corporation, Arlington, VA (US)

(21) Appl. No.: 18/639,003

(22) Filed: Apr. 18, 2024

Related U.S. Application Data
(60) Provisional application No. 63/460,223, filed on Apr. 18, 2023.

(51) Int. Cl. H02S 50/15; G06T 7/00; G06T 7/11

(52) U.S. Cl. CPC H02S 50/15; G06T 7/0002; G06T 7/11; G06T 2207/10032; G06T 2207/20132

(57) ABSTRACT

A method and system for detecting one or both of soiling or shading on solar panels using computer vision is disclosed. Soiling and shading may decrease the amount of energy that may be generated by a solar farm. As such, computer vision may be used to determine whether or when to act to reduce the shading or soiling may in turn increase the energy generated. The computer vision for soiling and shading may be performed in combination, such as in terms of the results of the soiling and shading analysis may be used in combination, or in terms of the analysis itself being performed in combination.

### REFERENCE TO RELATED APPLICATION

The present application claims priority to U.S. Provisional Application Ser. No. 63/460,223 (filed on Apr. 18, 2023), which is incorporated by reference herein in its entirety.

### FIELD OF THE INVENTION

The present application relates generally to determine one or both of shading or soiling of solar panels using computer vision.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Solar panels may be installed in large areas called solar farms that may span a significant geographic footprint. At times, the solar panels (interchangeably termed panels) may be proximate to vegetation, which may result in the vegetation casting a shadow on the solar panels, in turn decreasing the amount of energy generated by the solar panels. Moreover, the solar panels may become soiled, similarly decreasing the amount of energy generated by the solar panels.

### SUMMARY

In one or some embodiments, a computer-implemented method for increasing power generated by solar panels in a solar farm is disclosed. The method includes: accessing at least one image that includes the solar panels in the solar farm; determining at least one visual aspect of one or both of an environment of the solar farm or of the solar panels; using the at least one aspect of one or both of an environment of the solar farm or of the solar panels in order to perform one or both of: (i) masking of the at least one image; or (ii) analyzing the at least one image in order to determine one or both of soiling on or shading of the solar panels; and performing one or both of: generating an output image in order to identify or indicate the one or both of the soiling on or the shading of the solar panels; or automatically performing at least one action in order to reduce the soiling on or the shading on the solar panels.

In one or some embodiments, a computer-implemented method for increasing power generated by solar panels in a solar farm is disclosed. The method includes: accessing at least one image that includes the solar panels in the solar farm; and performing in combination one or more of: masking prior to soiling analysis and masking prior to shading analysis in combination; performing the soiling analysis and the shading analysis in combination; or power analysis to determine power loss due to soiling and shading in combination.

In one or some embodiments, a computer-implemented method of reducing shading on solar panels in a solar farm is disclosed. The method includes: identifying the solar panels in the solar farm within at least one image based on one or both of geometric analysis or pixel-based analysis of the at least one image; identifying shading on the solar panels by: iteratively performing the pixel-based analysis on at least two different types of images; and determining the shading on the solar panels based on the iterative analysis; and performing one or both of: modifying an output image in order to identify the determined shading on the solar panels; or automatically performing at least one action in order to reduce the shading on the solar panels.

In one or some embodiments, a method of reducing soiling on solar panels in a solar farm is disclosed. The method includes: identifying the solar panels in the solar farm within at least one image based on one or both of geometric analysis or pixel-based analysis of the at least one image; performing pixel-based analysis on the at least one image in order to determine soiling on the solar panels; determining one or both of whether to clean at least some of the solar panels or which of the solar panels to clean based on both the pixel-based analysis and a non-pixel-based analysis; and performing one or both of: modifying an output image in order to identify which of the solar panels to clean; or automatically performing at least one action in order to clean one or more of the solar panels.

In one or some embodiments, a method of performing shading analysis and soiling analysis of solar panels in a solar farm is disclosed. The method includes: identifying the solar panels in the solar farm within at least one image based on one or both of geometric analysis or pixel-based analysis of the at least one image; performing pixel-based analysis on the at least one image in order to determine shading on the solar panels; performing the pixel-based analysis on the at least one image in order to determine soiling on the solar panels; wherein the shading and the soiling are performed in combination to determine at least one aspect of the solar farm based on one or both of: the pixel-based analysis to determine the shading on the solar panels and to determine the soiling on the solar panels are performed in combination; or results from the pixel-based analysis to determine the shading on the solar panels and to determine the soiling on the solar panels are used in combination; and performing at least one action based on the at least one aspect of the solar farm.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is a block diagram illustrating a high-level system architecture for determining one or both of shading or soiling of the solar panels, and for performing one or more actions responsive to the determination.

FIG. 2A is a flow diagram for analyzing historical or forecasted performance and further analysis to improve the performance.

FIG. 2B is a higher-level flow diagram for determining both of shading and soiling of the solar panels.

FIG. 2C is a flow diagram for determining one or both of shading or soiling, performing a power analysis, and performing one or more corrections.

FIG. 2D is a flow diagram for clipping an image of the solar farm based on one or more metrics of the solar farm.

FIG. 2E is a flow diagram for determining soiling and/or shadowing tile-by-tile in an image or a subpart of the image.

FIG. 2F is a flow diagram of the power analysis.

FIGS. 3A-D illustrate a more detailed flow diagram for determining both of shading and soiling of the solar panels.

FIG. 4A is an example of a visual range satellite image of an area that includes a solar farm.

FIG. 4B is an example of a surface reflectance satellite image of the area that includes the solar farm.

FIG. 4C is an example of graphical chart of a wind rose that characterizes the speed and direction of winds at the area that includes the solar farm.

FIG. 4D is an example of graphical chart of a solar path that characterizes the sun's position at the area that includes the solar farm.

FIG. 4E is an example soiling profile output of a Kimber model detailing the soiling buildup fraction and the precipitation over a time period.

FIG. 4F is an example soiling profile output of an HSU model detailing the transmission ratio changes over time due to soiling.

FIG. 4G is an example soiling profile output of the computer vision analysis predicting the soiling buildup fraction over a time period.

FIG. 4H is an example image of indicating sequence of cleaning solar panels.

FIG. 5 is a diagram of an exemplary computer system that may be utilized to implement the methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, collections of solar panels may form a solar farm that generates energy. The solar farm may have its corresponding energy output reduced due to one or more circumstances. In this regard, one or more applications may be used in order to: (i) analyze potential causes for the decrease; and/or (ii) take one or more actions in order increase the energy output due to the various circumstances. One application may be configured to determine whether soiling is the cause for the decrease in energy output and responsive actions to perform. For example, the application may be configured to determine soiling of the solar panel(s) and may further determine any one, any combination, or all of: whether to initiate cleaning of the solar panels (such as automatic cleaning); when to initiate cleaning of the solar panels; and in what sequence of solar panels to perform the cleaning in order to increase the amount of energy generated by the solar farm. Another application may be configured to determine whether shading is the cause for the decrease in energy output and responsive actions to perform. For example, the application may determine shading on the solar panels due to cloud cover; however, in such an instance, little can be done to increase the amount of energy generated by the solar farm. Alternatively, or in addition, still another application may determine shading on the solar panels due to vegetation, trees, and the like. As discussed in more detail below, responsive to determine shading, one or more actions may be performed in order to determine whether and/or how and/or in what sequence to reduce shading. Yet another application comprises determining inter-panel shading in which two solar panels, at different elevations and determining how to modify positioning of the panels responsive thereto.

Yet another application comprises evaluating the solar farm for a combination of factors that may affect performance, including any one, any combination, or all of: shading; soiling; quality of the solar panels; site selection; or operation of the solar panels (e.g., tilting of the panels). In one or some embodiments, the solar farm may be tasked with generating a predetermined amount of energy. Alternatively, the solar farm may be part of a number of energy generation sources, such as one or more other solar farms, one or more wind farms, one or more hydroelectric power generators, etc., each of which may be tasked with generating a predetermined amount of energy. In either instance, the evaluation of the performance of the solar farm may comprise: determining the forecasted amount of power that may be generated from the solar farm in an upcoming period (e.g., upcoming day, month, year, etc.); comparison of the forecasted amount of power with the amount of power committed to be generated (e.g., previously committed to be generated by contract; committed to be generated in real-time; future commitments of energy); and determination as to one or more actions to perform responsive to the comparison. For example, responsive to the forecasted amount of power being less than the amount of power committed to be generated, one or more reasons may be determined (e.g., any one, any combination, or all of: shading; soiling; quality of the solar panels; site selection; or operation of the solar panels) and responsive thereto, one or more actions may be taken (e.g., any one, any combination, or all of the following actions may be taken: cleaning (such as automatic cleaning); removing vegetation/trees; changing tilting of the solar panels; etc.).

In one or some embodiments, a predetermined sequence of determining the causes of performance degradation may comprise first determining, using one or more analysis tools, whether one or both of soiling or shading caused (or will cause) the performance degradation. After determining that soiling and shading do not cause (or do not sufficiently cause) the performance degradation, other causes may be considered, such as the solar panels themselves (e.g., the quality of the solar panels); the site of the solar farm; and/or the operation of the solar panels (e.g., whether the automatic operation of the tilting of the panels may be modified, such as the range of tilting of the solar panels may be modified). In this regard, the analysis tools, such as the shading and/or soiling analysis tools, may be used to determine: (1) whether the solar farm is underperforming; (2) whether the solar farm is underperforming for predetermined reasons, such as soiling and/or shading; and/or (3) whether the solar farm is underperforming for other unknown reasons.

Thus, in practice, solar farms may be prone to one or both of shading or soiling, each of which may reduce the amount of electricity generated by the solar farm. Typically, determining shading may involve a labor-intensive process in which the solar panels are visually inspected. Further, determining soiling may involve visual inspection or reliance on soiling sensors present on the panels.

Regardless, shadow formation and soiling may be important for one or more reasons including to: characterize solar farm performance; determine whether, when, and/or which solar panels to clean; or determine whether or when to clear proximate vegetation. In this regard, understanding soiling formation and/or vegetation growth may assist in scheduling cleaning and maintenance activities.

Typically, shading may be reduced by the removal of the proximate vegetation, which may be performed in one of several ways. In one way, a worker may, under his/her own power, clear the vegetation. In another way, the vegetation clearing may be performed at least partly automatically. As one example, a drone, or the like, may be used in order clear the vegetation. In one embodiment, the drone is fully automated, without operator control. Alternatively, the drone may be under the control of an operator.

Typically, solar panels may be cleaned in one of several ways. In one way, the solar panels may be tilted (with titling scheduled when there is rain and/or regardless of the rain schedule) so that the dirt may slide off the solar panels. However, the dirt may be electrostatic, thereby clinging to the solar panels, particularly solar panels that are coated with anti-radiation coating that is sticky in nature. In another way, the solar panels may be cleaned, such as automatically cleaned. Merely by way of example, responsive to determining to clean solar panels, an output, such as a visual output, may be generated. The output may include any one, any combination, or all of: indication of which solar panels to be cleaned; an order of the solar panels are to be cleaned; or a timing as to when the solar panels are to be cleaned. In one or some embodiments, the visual output may comprise an image that includes additional information integrated therein or overlayed thereon any one, any combination, or all of: indication of which solar panels to be cleaned; an order of the solar panels are to be cleaned; or a timing as to when the solar panels are to be cleaned. Merely by way of example, a pin, tag, icon or the like may be superimposed on the image that indicates for a respective solar panel (whether the information is indicated on the pin, tag, icon or the like or whether part or all of information is generated (such as in a pop-up window) when clicking on the pin, tag, icon or the like).

In one embodiment, the output, such as the visual output, may be sent to a person to manually perform the cleaning. Alternatively, or in addition, the output may be transmitted to an automatic solar panel cleaning system to perform the automatic solar panel cleaning.

Thus, in one or some embodiments, various potential reasons for the decrease in energy output of the solar farm, such as soiling, shading, or the like, may be analyzed separately. Alternatively, the various reasons for the decrease in energy output of the solar farm, such as soiling and shading, may be analyzed in combination. As discussed in more detail below, the combined analysis may be in one or both of the following: (1) the results of the soiling analysis and the results of the shading analysis may be combined in order to (from a combined standpoint) increase the energy output of the solar farm; or (2) the analysis itself is performed in a combined manner (e.g., there is a commonality of the analysis, such as identifying solar panels within a respective image may be used for both the subsequent soiling analysis and the subsequent shading analysis; there is a contrasting of the analysis, such as analysis of the pixel values may be different (e.g., mutually exclusive from one another) for soiling and shading).

Thus, in one or some embodiments, a computer-implemented method for increasing power generated by solar panels in a solar farm is disclosed. The method includes: accessing at least one image that includes the solar panels in the solar farm; determining at least one visual aspect of one or both of an environment of the solar farm or of the solar panels (e.g., at least one aspect of sunlight; at least one aspect of reflectance of the sunlight; albedo, etc.); using the at least one aspect of one or both of an environment of the solar farm or of the solar panels in order to perform one or both of: (i) masking of the at least one image; or (ii) analyzing the at least one image in order to determine one or both of soiling on or shading of the solar panels; and performing one or both of: generating an output image (e.g., generating may comprise modifying part or all of the underlying satellite image) in order to identify or indicate the one or both of the soiling on or the shading of the solar panels; or automatically performing at least one action (e.g., fully automatic cleaning and/or automatic cleaning triggered by a manual input) in order to reduce the soiling on or the shading on the solar panels.

In one or some embodiments, the step(s) to determine soiling are entirely different from the step(s) to determine shading. Alternatively, determining the soiling and determining the shading may be performed at least partly in combination (e.g., have a common basis, common methodology, common metric(s), etc.) such as one or both of the following is performed in combination: the masking of the at least one image or the analyzing the at least one image. As one example, a same visual aspect (e.g., albedo) is used for determining both the soiling on and the shading of the solar panels. As another example, masking of the at least one image is performed in combination for both determining the soiling and determining the shading (e.g., a first masking for the at least one image is performed based on a same visual aspect (e.g., albedo) for determining the soiling and a second masking for the at least one image is performed based on the same visual aspect for determining the shading). In particular, albedo may be used for masking of the at least one image in advance of the soiling analysis, and may also be used for masking of the at least one image in advance of the soiling analysis (though, in one or some embodiments, the masking using albedo may be different for the soiling analysis than for the shading analysis). As yet another example, analyzing (such as pixel analysis) of the at least one image is performed in combination for both determining the soiling and determining the shading. In particular, pixel analysis for the at least one image is performed may be based on a same visual aspect (e.g., albedo) for determining the soiling as for determining shading (though, in one or some embodiments, the albedo may select different ranges of pixels for the soiling analysis than for the shading analysis). Various other examples of working in combination are discussed further below.

Thus, in one or some embodiments, the analysis (such as the pixel-based analysis) may be paired with a power analysis, which may comprise a determination whether: (i) there is a decrease in the power generated from part (e.g., an individual solar panel; a set of solar panels; an area of solar panels; etc.) or all of the solar farm; and/or (ii) the decrease is attributable to one or both of soiling or shading (and more specifically whether the recommended correction, given the costs associated with cleaning solar panels or removing vegetation, is outweighed (such as outweighed by at least a certain amount, certain percentage) the increase in power generated by the solar farm resulting from the recommended correction). In this regard, in one or some embodiments, the power analysis may include analyzing power (such as power loss) due to both soiling and shading in combination (e.g., power loss attributed to both shading and soiling as one example of the in combination power analysis).

As part of the power analysis (such as the in-combination power analysis), various metrics are contemplated to correlate soiling and/or shading with the associated power generated (e.g., effectively converting the soiling indicator and/or shading indicator into a power indicator). In one or some embodiments, power blocks may be used as a metric for the correlation. In particular, the solar farm may be divided into a plurality of power blocks, which may be used in converting soiling indicator(s) and/or shading indicator(s) to power indicator(s) (e.g., power estimation and/or power loss). As one example, a respective power block may be defined with one or more solar panels (such as multiple solar panels). Alternatively, or in addition, a respective power block may be defined as having only part, but not all, of a respective solar panel (e.g., the respective power block may have one or more partial solar panels and/or one or more entire solar panels). In one or some embodiments, the power blocks may be analyzed in one of several ways, such as any one, any combination, or all of: (i) analyzing a respective power block for different iterations (e.g., in order to determine whether any one, any combination, or all of power, soiling, or shading has changed, and by how much over a predetermined time period, thereby analyzing power differences with regard to soiling and/or shading over time); (ii) analyzing the respective power block with respect to other power block(s) (e.g., for a same image, the respective power block may be compared with other power block(s) to examine whether the respective power block is underperforming as compared to the other power block(s) in the solar farm); (iii) analyzing the respective power block(s) for shading and soiling in combination (e.g., an analysis of power decrease due to soiling versus shading, such as percentage power loss due to shading and due to soiling for the power block(s)). In this way, the system may determine whether certain power block(s) for the solar farm are underperforming (e.g., how much power loss (on the solar farm level, on a plurality of power blocks group level, or on the individual power block level) is attributed to shading and/or soiling); how much power loss. Further, in this way, the power analysis may comprise an additional way in which to integrate the soiling and shading analysis. For example, in one or some embodiments, the masking predicate to performing the soiling analysis and the shading analysis may be in combination or integrated (e.g., based on albedo), as discussed above. Alternatively, or in addition, after performing the soiling analysis and/or the shading analysis (whether in combination or not), the power analysis may be performed in an integrated manner (e.g., determining whether the power loss is more due to shading or soiling).

In one or some embodiments, responsive to determining that certain power block(s) for the solar farm are underperforming, the system may perform additional analysis to determine whether (or how much) additional power may be generated by at least partly correcting for: soiling by cleaning the solar panel(s) assigned to the certain power block(s) and/or shading by at least partly removing vegetation proximate to the solar panel(s) assigned to the certain power block(s). As discussed above, cleaning and removing vegetation incur cost. For example, removing vegetation may require significant resources. As such, prior to initiating cleaning of solar panels or removing vegetation proximate to solar panels, the system may determine an amount of increase in power due to the cleaning of solar panels or removing vegetation proximate to solar panels. The determined amount of increase may then be analyzed prior to initiating cleaning of solar panels or removing vegetation proximate to solar panels (e.g., initiating cleaning or removing vegetation only in response to the cost benefit due to the increase in the amount of power being greater than a predetermined dollar amount; initiating cleaning or removing vegetation only in response to the cost benefit due to the increase in the amount of power being a predetermined amount greater than (e.g., two times greater than; four times greater than) the cost of performing the cleaning and/or the cost of removing the vegetation).

Further, in one or some embodiments, one or more predicate steps may be performed prior to: masking in advance of (or as part of) the shading analysis and/or soiling analysis; and/or prior to performing the shading analysis and/or soiling analysis. Various predicate steps are contemplated including any one, any combination, or all of: identifying structures within or proximate to the solar farm; analyzing one or more types of images as a trigger to determine whether to perform the masking and/or analysis; performing visual correction; or clipping of a subpart of the image.

As one example, with regard to identifying structures, the system may identify non-movable structures, such as residences, buildings or the like, and/or identify movable structures, such as vehicles (whether parked or moving). In this way, the system may estimate proximity of these vehicles to large installed facilities in order to tag and label the vehicles accordingly. Alternatively, or in addition, the system may identify and distinguish moving vehicular traffic in order to separate such from the solar panels of the solar farm (e.g., clip the image, as discussed below, in order to remove vehicles or vehicular traffic).

As another example, the system may analyze one or more types of images (such as a lower-resolution image and a higher-resolution image) as a trigger to determine whether to perform the masking and/or analysis. In particular, a pixel size as set to a predetermined number (e.g., 25) may be reduced to or better align to a smaller observable darker pixel (e.g., <40 on the RGB scale, as discussed further below). Such a lower resolution image (which may be different from the higher-resolution visual range image and/or the surface reflectance false color (SRFC) datasets from a surface reflectance image) may be thus analyzed for the darker pixels. In particular, metadata of these lower-resolution images, such as AQI (Air Quality Index) (e.g., AOD (Aerosol Optical Depth)) may be monitored to predict deterioration sufficient to indicate possibility of ground soiling. In this regard, analysis of the lower-resolution image (such as the metadata and/or the pixel data of the lower-resolution image) may be used as a trigger to determine whether to perform additional analysis (such as masking and/or analysis of the higher resolution image). In this way, once soiling possibility and/or shading possibility is statistically confirmed (using the lower-resolution image analysis), the extent of soiling and/or shading (and the associated cleaning schedule and/or vegetation removal schedule) may be determined via the use of one or more higher-resolution images. Thus, using the analysis of the multiple images (such as the lower-resolution image(s) and the higher-resolution image(s) may harmonize the economics and computational requirements.

Yet another example predicate step may comprise performing visual correction. As one example, prior to shading analysis and/or soiling analysis, solarization and/or gamma correction may be performed as part of the image preparation process. In this way, the visual correction may result in enhanced visibility and thus detectability (e.g., detecting the dark pixels in the process of determining shading).

Still another example predicate step may comprise clipping or selecting one or more subparts of an underlying image (such as one or more subparts of an underlying satellite image). The system may determine to divide the underlying image, such as based on any one, any combination, or all of: analysis of the underlying image identifying objects subject to interest (e.g., solar panels); analysis of the underlying image identifying objects not subject to interest (e.g., vehicles); or analysis of the underlying image identifying objects subject to interest that may vary (e.g., different sections of image with different albedo numbers). Responsive to the analysis, the system may thus clip the underlying image as part of image preparation prior to analysis. So that, the clipping or trimming of the image may reduce contribution from region(s) removed so that the soiling and/or shading analysis is not skewed. Further, even with clipping or trimming the underlying image, the absolute position (e.g., the latitude/longitude or the absolute position) may still be ultimately determined (e.g., via translations) for purposes of cleaning solar panels or clearing vegetation. In this way, the system may trim and/or crop the underlying image (e.g., the sourced satellite image) to the area of interest (AOI) or to the region of interest (ROI).

Thus, in one or some embodiments, pixel values for an associated image may be analyzed in order to determine soiling and/or shading. The pixel value analysis may comprise pixel chemistry, in which the values of the pixels may be ascribed a certain chemical attribute (e.g., the pixel values carry therewith implications of the underlying chemistry). As one example, a respective pixel value may implicate whether there is shading on the solar panel. As another example, the respective pixel value may implicate whether there is soiling on the solar panel. As still another example, the respective pixel value may implicate whether there is both shading and soiling on the solar panel. The pixel chemistry analysis may thus consider any one, any combination, or all three of these examples. In practice, a soiled panel may exhibit certain pixel values depending on whether the soil is dirt, dust, or the like. Thus, the specific nature of the dust may exhibit a certain pixel value (e.g., dirt from the southwest United States may be more orange whereas dirt from a more fertile region may be more brown in color). Thus, in one or some embodiments, to consider varying types of soiling, colors from a range of a plurality (such as 3) major colors of dust, such as yellow orange and brown, may be included in predetermined pixel values (or ranges of pixel values) thereby identifying the different types of soiling. Further, a shaded panel may exhibit other pixel values (such as mutually exclusively different pixel values) that reflect darker, such as black or nearly black, colors. Further, in practice, a panel may be simultaneously soiled and shaded. In such an instance, the pixel values carry both information on soiling and on shading. As discussed in more detail below, in such an instance of soiling and shading, it may be difficult to differentiate between both (e.g., a darker pixel due to shading is, in effect, superimposed on a lighter pixel due to soiling). As such, the analysis may consider such a combined instance of soiling and shading. Merely by way of example, A greener terrain (e.g., due to vegetation or proximity to a farm) where an RGB vector is dominated by green (and all its associated shades) may be better analyzed by the RGB image type whilst for non-green terrains (desert, snow, saline), an ortho pan-sharpened image may be better.

In particular, in one or some embodiments, the pixel analysis may generate multiple results, such as performing pixel analysis on two separate images, in order to generate the multiple results. For example, the pixel values from two different types of images, such as a visual range image and a surface reflectance image, may be analyzed in order to generate the multiple results. In one or some embodiments, the multiple results may be interpreted as a range of results (e.g., the pixel analysis from analyzing the visual range image comprises a lower bound for potential shading and the pixel analysis from analyzing the surface reflectance image comprises an upper bound for potential shading), with the actual shading potentially being within the designated range. In this way, the pixel analysis does not result in a single value to determine shading; instead, the multiple values generated (resulting in the range) may be used for interpretation of shading. Therefore, because it may be difficult to separate shading from soiling from a pixel analysis standpoint, the range is generated using analysis of the visual range image and the surface reflectance image. Thus, in one or some embodiments, the analysis may effectively favor the considerations of shading over soiling (e.g., analytically speaking, shading may take computer vision precedence over soiling).

Thus, in one or some embodiments, computer vision is used in order to determine one or both of shading or soiling. Computer vision may comprise analyzing one or more types of images (such as satellite digital images) in order to extract soiling and/or shading information from the images. Specifically, the disclosed computer vision solution may analyze satellite imagery in order to: estimate the net shadow formation in the solar farm along with providing panel specific shadow impact; and/or perform pixel-based soiling analysis as a time series to better comprehend panel cleanliness across a variety of conditions (e.g., any one, any combination, or all of: weather; climatic; and air quality levels). Responsive to the analysis, one or more actions may be performed, including any one, any combination, or all of: performing cleaning (e.g., performing an automatic cleaning sequence based on the determined soiling indicator (e.g., a panel soiling health score derived from pixel color code)); generating one or more outputs with regard to vegetation growth (e.g., modifying an image, such as by generating an overlay, in order to indicate one or more areas in which to remove vegetation growth; generating a communication, such as an email or the like, to an operator that indicates to the operator where and/or when to remove vegetation growth); or generating one or more outputs indicative of solar farm performance (e.g., the soiling and shading may be analyzed in combination in order to determine a percent degradation of performance of the solar farm; the soiling and shading may be analyzed in combination in order to automatically design layouts of new solar farms or additional solar panels at the current solar farm).

Various examples of performing the soiling and shading analysis in combination are contemplated and may comprise any one, any combination, or all of the following: (1) a common input used (e.g., the same satellite images used to perform the soiling analysis and/or common visual aspect (such as albedo)); (2) at least partly common analysis (e.g., masking based on the common visual aspect prior to analysis and/or analysis (such as pixel analysis) to identify the solar panels within the satellite image(s) may be used both for the subsequent shading analysis and the subsequent soiling analysis and/or pixel analysis to identify predetermined values for pixels and/or power analysis of soiling and shading in combination); or (3) at least partly contrasting analysis (e.g., pixel analysis for shading and for soiling uses at least a partly different ranges, such as a mutually exclusive ranges (darker pixels used to identify shading versus lighter pixels used to identify soiling); and/or pixel analysis for shading uses a current satellite image to determine shading versus the pixel analysis for soiling using a time-series of satellite images obtained over a period of time to determine a trend in soiling; and/or power analysis compares power loss associated with soiling versus shading).

As discussed above, the identification of the solar panels within a respective satellite image may be common to both the shading analysis and the soiling analysis. In one or some embodiments, the identification of the solar panels with the respective satellite image may be based on one or both of geometric analysis and pixel analysis. In one or some embodiments, the geometric analysis may comprise one or both of edge detection and corner detection. In one or some embodiments, if both of the geometric and pixel analysis are consistent with one another (e.g., the geometric analysis indicates a tile and the color attributes likewise indicate a tile), then a section of the image (such as a tile) may be marked as a region of interest.

Further, in one or some embodiments, the pixel analysis may comprise analyzing values of pixels in the respective satellite image. More specifically, the pixel analysis with regard to shading may comprise a predetermined color combination (or predetermined ranges of colors). Thus, the predetermined color combination may be reflective of the actual chemical composition as reflected by the pixel. In one particular example in which pixel values are designated as Red (R), Green (G), and Blue (B), any one, any combination, or all of the RGB pixel values may be analyzed to identify predetermined values (or predetermined value ranges). As such, in one example, identification of the particular pixel values may comprise identifying whether one of the RGB pixel values are within the predetermined value range of the one of the RGB pixel values (e.g., one of R, G, or B). As another example, identification of the particular pixel values may comprise identifying whether two of the RGB pixel values are within the respective predetermined value range of the two of the RGB pixel values (e.g., two of R, G, or B). As still another example, identification of the particular pixel values may comprise identifying whether each of the RGB pixel values are within the respective predetermined value range of each of the RGB pixel values (e.g., all of R, G, or B).

In one or some embodiments, responsive to identifying solar panels (e.g., a respective tile is marked as a region of interest), additional analysis is performed in order to confirm that the region of interest includes solar panels and/or to confirm that shading is present in the region of interest. In one or some embodiments, the additional analysis comprises cluster analysis. For example, one or more clusters may be identified within a respective tile marked as a region of interest (e.g., top five color clusters). Clustering may comprise identifying commonly occurring pixel values in the respective tile and further identifying a center of the cluster. Thus, a respective cluster may be identified as shaded responsive to the respective cluster having pixel values less than a predetermined threshold.

Alternatively, or in addition, the pixel analysis with regard to shading may comprise identification of pixel growth, in which one or more clusters of pixels may be identified. In this regard, in one or some embodiments, the pixel analysis may use the identification of the pixel values in combination with the identification of the one or more clusters in order to identify shading. For example, the pixel analysis may identify darker pixels, which may be indicative of a clean panel (e.g., unsoiled panel) or a shaded panel. After which, cluster analysis may comprise identifying contiguous groups of similarly valued darker pixels in order to identify the shading. In the particular example in which pixel values are designated as RGB, any one, any combination, or all of the RGB pixel values may be analyzed to identify clusters of predetermined values (or predetermined value ranges). As such, in one example, cluster analysis may identify cluster(s) of one of the RGB pixel values within the predetermined value range of the one of the RGB pixel values (e.g., one of R, G, or B). As another example, cluster analysis may identify cluster(s) of two of the RGB pixel values within the respective predetermined value range of the two of the RGB pixel values (e.g., two of R, G, or B). As still another example, cluster analysis may identify cluster(s) of each of the RGB pixel values within the predetermined value range of each of the RGB pixel values (e.g., each of R, G, or B). As still another example, cluster analysis may identify cluster(s) of two of the RGB pixel values within the respective predetermined value range of the two of the RGB pixel values (e.g., all of R, G, or B). Thus, the pixel analysis, including the pixel value analysis and clustering, may identify shading, which may be represented in one of several ways, including a percentage of shading (e.g., the estimated percentage of shading of the identified solar panels in the respective satellite image).

As one example, clustering may include identifying at least one (such as only one) of the RGB pixel values that are common to a set of pixels proximate to one another. In order to differentiate between a solar panel that is clean (and that will have darker pixel values across the solar panel) from a solar panel that is partially shaded (and that will have subsections of the solar panel having darker pixel values), the number of clusters and/or the center of a respective cluster may be analyzed. In practice, if the darker pixels form a single cluster center, the methodology may determine that the cluster is due to a clean panel. In contrast, if multiple clusters, with different cluster centers are identified for a respective panel, the methodology may designate the multiple clusters as shading.

Further, in one or some embodiments, the shading analysis may comprise analysis of a plurality of different types of images. As one example, the shading analysis may comprise analyzing at least one visual range image and at least non-visual range image. A non-visual range image may comprise at least a part of the information within the non-visual range image being outside of the visual range. In one example, the non-visual range image may be mutually exclusive of the visual range. In another example, the non-visual range image may include at least a part of the non-visual range and at least a part of the visual range.

Various non-visual range images are contemplated. As one example, a surface reflectance image may comprise a non-visual range image. For example, the surface reflectance image (also termed a surface reflectance false color image) may be generated by a satellite and comprise the wavelength at which the earth surface or any surface reflects a particular color, which may be selected based on certain items of interest or not of interest (e.g., vegetation that is proximate to the solar panels). Thus, the selection of the particular color may be considered an artificial color or a false color, with the surface reflectance image comprising a false color image. So that, areas of marginal interest may be assigned an artificial color (e.g., red). In this way, the same satellite that captures the visual image in the visual spectrum may also capture different images, such as in any one, any combination, or all of: the near-IR region; top of atmosphere; or surface reflectance mode. Thus, the analysis may use two separately generated images of the same region but in different modes of capture (e.g., visual mode and surface reflectance mode).

In this regard, the above-described pixel analysis for shading, which may include one or both of identifying the pixel values and identifying clusters, may be performed for each of the at least one visual image and the at least one non-visual range image. As such, the identified shading (e.g., the estimated percentage of shading of the identified solar panels) may be generated for each of the at least one visual image and the at least one non-visual range image. In one or some embodiments, the identified shading based on each of the at least one visual image and the at least one non-visual range image may be used in combination. As one example, the estimated percentage of shading based on analysis of the visual image and the estimated percentage of shading based on analysis of the non-visual range image (e.g., the surface reflectance image) may be used to determine a range of shading.

In one or some embodiments, the estimated percentage of shading from the visual image is lower than the estimated percentage of shading from the surface reflectance image due to one or both of: greater potential area for solar panels in the surface reflectance image; and shadows in between panels may also have been captured in the analysis of the surface reflectance image whereas in the analysis of visual image, the edge shadows may have been captured but not the in-between shadows. In this regard, the analysis of the surface reflectance image may act as a complement to the analysis of the visual image. As such, the estimated percentage of shading from the visual image may be the lower bound of the defined range and the estimated percentage of shading from the surface reflectance image may be the upper bound of the defined range, with the defined range being used as the range of potential shading values.

In one or some embodiments, the range of shading may be analyzed. For instance, the range may be analyzed for its breadth. In the event that the breadth of the range is greater than a predetermined amount, one of the values defining the range may be rejected, with the shading analysis being reliant on the remaining value defining the range. For example, in the event that the percent shading based on the surface reflectance image is more than a predetermined amount from the percent shading based on the visual image, the percent shading based on the surface reflectance is rejected and the shading determination is based on the percent shading based on the visual image.

The predetermined amount for the breadth of the range of shading may vary. In one instance, the predetermined amount is 10%. As such, both values in a range of 6.5% (based on the analysis of the visual image) to 15.8% (based on the analysis of the surface reflectance image) may be used. In turn, the range may provide the basis in which to determine the amount of shading in the solar farm. In one or some embodiments, the amount of shading in the solar farm is selected within the range.

Separate from analyzing a single range, in one or some embodiments, trends in the ranges may be analyzed to determine whether one or more actions are to be performed. In particular, responsive to determining that both numbers defining the range are increasing and/or responsive to determining that the breadth of the range in increasing, the methodology may determine that shadowing at the solar farm is increasing, resulting in automatically triggering tree trimming or the like.

In one or some embodiments, soiling analysis may be performed independently of the above-described pixel analysis. Alternatively, the soiling analysis may be performed in combination with the above-described shading analysis. As one example, masking (e.g., based on a common masking metric such as albedo) may be common predicate to the soiling analysis and shading analysis. As another example, the identification of the solar panels with the satellite image(s) may be commonly used in both the soiling analysis and the shading analysis.

In particular, in one or some embodiments, the soiling analysis is based, at least in part, on pixel value analysis (interchangeably term pixel analysis). In one or some embodiments, the pixel analysis with regard to soiling may be different from the pixel analysis for shading. This may be due to soiling being different from shading in one or more of the following ways: (1) shading may be seen as instantaneous whereas soiling may be both instantaneous and cumulative; (2) soiling has chemical effects; and (3) soiling may be in 3 dimensions (both coverage (area) on the panel and thickness (accumulation)) whereas shading may be in 2 dimensions.

In one or some embodiments, the pixel analysis for soiling may comprise a pixel-chemistry based analysis of the values of the pixels. In particular, soiling (such as due to dust, dirt, or the like) may have one or more particular colors that correspond to one or more different colors (e.g., orange, yellow, and/or brown) or different ranges of pixel values. These particular colors or ranges of pixel values may represent a particular signature akin to a chemical composition. As such, the particular colors or ranges of pixel values may comprise a pixel chemistry that is reflective of the actual chemical composition of the materials that are represented by the pixel values. In practice, the soiling analysis may identify pixels having particular values (e.g., indicative of one or more of the particular colors or particular ranges of pixel values) in the satellite image.

Thus, clustering may be performed for one or both of shading or soiling. In one or some embodiments, clustering is configured to identify dominant colors within a respective image (e.g., within a respective tile or subdivided section of an image). In this regard, clustering for soiling or shading may be performed based on identifying different colors of pixels for clustering (e.g., pixel values >40 are for soiling versus pixel values <40 are for shading). In practice, clustering may identify dominant colors (e.g., the five dominant colors) within a respective tile, with the dominant colors identified being used to determine whether there is soiling and/or shading (e.g., dominant color(s) >40 indicative of soiling; dominant color(s)<40 indicative of shading). Various manners are contemplated to determine dominance of a color. Thus, in one or some embodiments, clustering is focused on the image (or subpart of the image, such as the respective tile) instead of on the solar panels identified within the image (or within the respective tile).

Separate from (and potentially in addition to) the analysis of pixel chemistry, the analysis may comprise pixel evolution, such as how the pixel chemistry changes over time (e.g., historically and/or predicting pixel chemistry changes into the future). As discussed in more detail below, pixel evolution may indicate changes in shading and/or soiling. By way of example, various actions may change soiling, such as rainfall (e.g., 20 mL of rainfall may be sufficient to clean a solar panel), tilting, or cleaning.

In one or some embodiments, the soiling analysis may include one or more inputs, such as a wind direction indicator. As one example, the wind direction indicator may comprise the wind rose. In one or some embodiments, the wind rose is a graphic tool indicative of wind speed and direction at a particular location (e.g., at the location of the wind farm). For example, the wind rose may indicate a single prevailing direction of the wind (e.g., southwesterly direction, meaning that the wind travels from northeast to southwest), thereby defining an axis. In turn, the soiling analysis may analyze the wind rose in order to determine which solar panels (previously identified) are along the defined axis, thereby indicating that the solar panels along the defined axis as being more prone to soiling, and further defining the sequence of cleaning (e.g., solar panels along the defined axis are automatically cleaned first). Alternatively, the wind rose may indicate a plurality of prevailing wind directions (such as a first primary direction that is southwestern, a second primary direction that is southern, etc.), thereby defining a plurality of axes (e.g., a first primary axis along the southwester direction; a second primary axis along the southern direction, etc.). In turn, the soiling analysis may analyze the wind rose to determine which solar panels (previously identified) are along a first primary axis, thereby ranking the solar panels for soiling according to which panels are along each of the defined axes, and further defining the sequence of cleaning (e.g., solar panels along the first primary axis are automatically cleaned first, the solar panels along the second primary axis are automatically cleaned second, etc.).

In this regard, the soiling analysis may analyze one or both of: soil models and/or wind direction, as discussed above. With regard to soil models, the soiling analysis may use soiling models to forecast soiling (e.g., a forecast of the number or percentage of orange, yellow and/or brown pixels per respective tile; a forecast of the health index, reflective of the soiling, in the respective tile). For example, the soiling analysis may analyze at least two different indices, such as at least three different indices, to determine whether to clean a respective tile. Specifically, the soiling analysis may analyze pixel chemistry in combination with one or more soiling models (e.g., one or both of a Kimber model or a Humboldt State University (HSU) model, discussed further below). In particular, the soiling analysis may analyze: (1) whether the Kimber model suggests there will be soiling; (2) whether the HSU model indicates a decreasing transmission ratio trend (indicating increasing soiling); and (3) whether the pixel chemistry analysis indicates soiling. In one or some embodiments, the pixel chemistry analysis may analyze different sections of the image, such as tile-by-tile, to determine whether a respective tile indicates soiling. The tile-by-tile analysis (performed by the pixel chemistry analysis) may be combined with other non-tile-based analyses using one or both of the Kimber model and the HSU model.

In addition to the analysis of the soiling models, wind direction may be analyzed. In one example, the wind direction indicator, such as the wind rose, may be analyzed. In one or some embodiments, the wind direction analysis may be tile-by-tile (e.g., measuring the angle between a respective tile's geometric center and the geometric center of the entire image). In turn, the measured angle may be compared with the wind direction indicator to determine whether the tile is along (or within a predetermined number of degrees of) the axis as defined by the wind direction indicator. In the example given above, the wind rose indicator is in the southwesterly direction (the axis is 450 or 225°). As such, tiles along the defined axis (or within ±100 of the axis) may be identified. In this way, the pixel chemistry analysis (which examines tile-by-tile for future pixel colors) and the wind direction analysis (which also examines tile-by-tile for proximity to the defined axis) may be used in combination to identify the sequence of tiles (and in turn the solar panels within the tiles) for cleaning. More specifically, the methodology may define the sequence based on one or both of the following conditions: (i) the tile's color index score (accumulation (or number of pixels) of orange, yellow and brown); and (ii) the tile's closeness to the defined axis. The tile with the highest color index score and the closest proximity to the defined axis may be listed as first in the sequence of cleaning. More generally, the sequence preferences may be defined as follows: high color index score and close proximity; high color index score and far proximity; low color index score and close proximity; and low color index score and far proximity.

In one or some embodiments, after the soiling analysis and/or the shading analysis (either individually or in combination), a power analysis may be performed (either individually or combination). As discussed above, the power analysis may include certain steps, which may ultimately result in identifying for cleaning and/or removing vegetation portions of the solar farm (e.g., any one, any combination, or all of: individual solar panels; groups of solar panels; sections or areas of the solar farm; positions (e.g., latitude/longitude; GPS coordinates); etc.). In one or some embodiments, in addition to identifying the portions of the solar farm, a sequence of performing the functions (e.g., cleaning and/or removing vegetation) for the identified portions of the solar farm may be included.

For example, these sequence preferences may be transmitted to the mapper function, which may generate an output indicative of the sequence of tiles for cleaning. For example, the mapper function may identify the sequence based on a series of latitude/longitude coordinates indicative of the locations of the solar panels to clean in a sequence. In one specific example, the mapper function may generate a graphical output, with latitude/longitude coordinates and color coding to indicate the sequence of cleaning (e.g., dark red (highest priority cleaning) to light red (lowest priority cleaning)).

Responsive to analyzing shading and/or soiling, one or more actions, such as one or more automatic actions, may be performed. In one or some embodiments, responsive to performing the shading analysis, which may determine the amount of shading, one or more actions may be triggered including any one, any combination, or all of: modification of an image to indicate where to remove vegetation; automatic triggering of communications, such as emails, to notify an operator to remove vegetation; automatic vegetation removal. Alternatively, or in addition, the shading analysis may identify a trend of shading, such as the increase in the amount of the determined shading over a predetermined time period (e.g., a percentage increase that is greater than a predetermined percentage may trigger performing the one or more actions). In response to identifying a trend (e.g., an increasing trend), the one or more actions may be performed.

In one or some embodiments, responsive to performing the soiling analysis, which may determine the amount of soiling, one or more actions may be triggered including any one, any combination, or all of: modification of an image to indicate which solar panels to clean and/or an order of cleaning; automatic triggering of communications, such as emails, to notify an operator to clean the solar panels; automatic control of cleaning devices to automatically clean solar panels in a designated sequence.

Alternatively, or in addition, the soiling analysis may identify a trend of soiling, such as the increase in the determined soiling, may trigger performing the one or more actions (e.g., a percentage soiling increase that is greater than a predetermined soiling percentage may trigger performing the one or more actions). For example, the soiling analysis may analyze satellite images obtained over a period of time (such as monthly), such as over the course of a plurality of months, to determine a trend. Automatic cleaning may be performed when the soiling analysis indicates that the accumulated percentage of soiling is greater than a predetermined amount (e.g., the predetermined amount may comprise a predetermined soiling percentage that may be selected from the range of 10-25%).

Thus, in practice, the predetermined soiling percentage may serve as a trigger to generally perform the one or more actions, such as the automatic cleaning sequence. In one or some embodiments, the predetermined soiling percentage may further serve as a basis to determine the sequence of cleaning when performing the automatic cleaning sequence. By way of example, the number of times a respective panel has exceeded the predetermined soiling percentage within a respective period may be used to determine the sequence of cleaning (e.g., the respective panel that has a highest number of times in a predetermined period (e.g., the past 12 months) where the soiling percentage for the respective panel greater than the predetermined soiling percentage is selected first to be cleaned).

In one or some embodiments, the soiling analysis and the shading analysis may be used in combination, such as for one or both of: performance characterization of the solar farm (e.g., an automatic comparison may be performed in which an initial model, indicative of the anticipated performance of the solar farm may be compared with the actual performance of the solar farm, accounting for the negative effect of soiling and shading, with the automatic comparison being used to send one or more automatic communications); or modification of layouts of future solar farm site(s). Thus, the soiling and shading analysis may be used to characterize the solar farm from one or both of a health perspective and a performance perspective, and may be used to modify one or more models used for layout and/or site selection. For example, solar panels are typically installed on flat (or nearly flat) surfaces for ease of tilting both in a clockwise and counter-clockwise manner. In a potential site that lacks a flat surface, the solar panels may be installed on a tilted surface, which may limit the ability of the solar panel to tilt past a certain angle and may limit the ability of self-cleaning. The performance characterization, based on both the soiling and shading analysis, may improve the one or more models and in turn improve the site selection process.

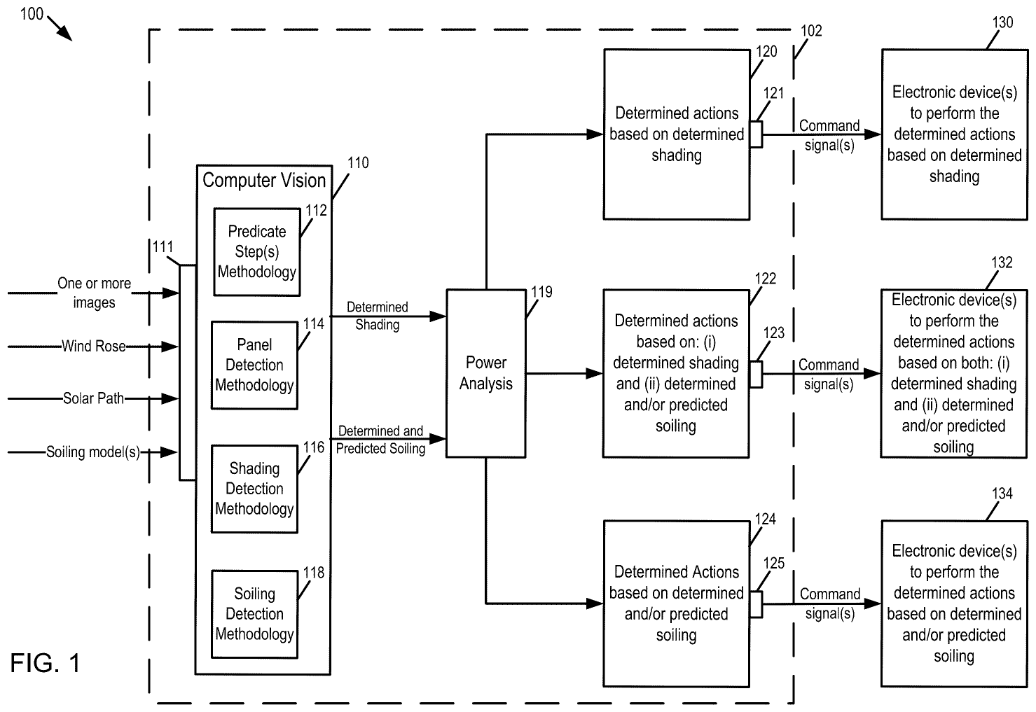

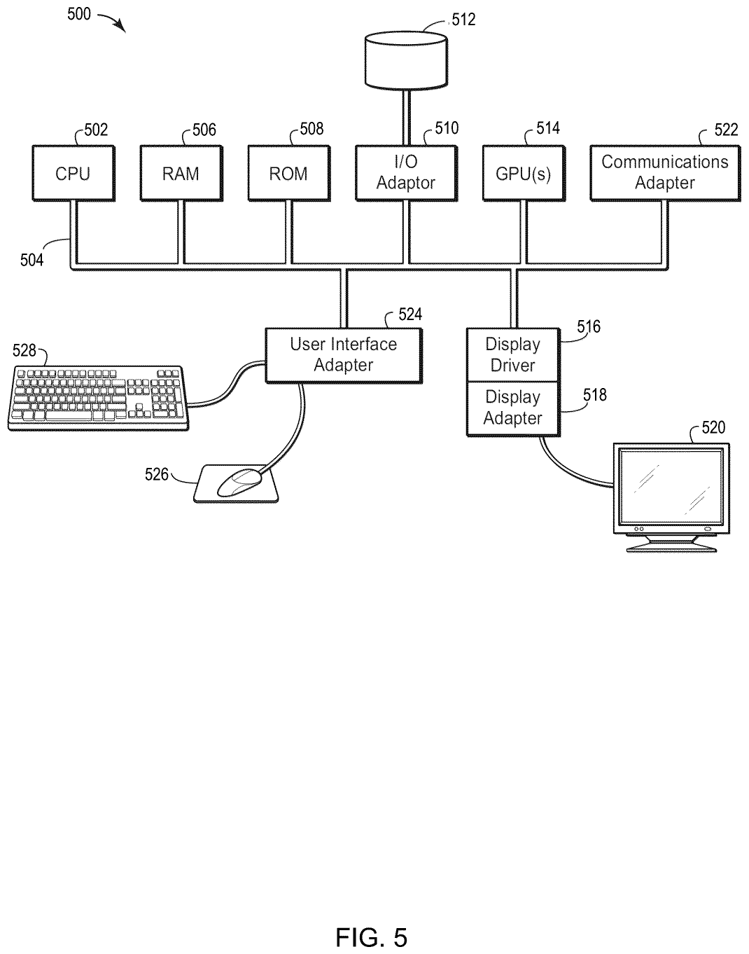

Referring to the figures, FIG. 1 is a block diagram 100 illustrating a high-level system architecture for determining one or both of shading or soiling of the solar panels, and for performing one or more actions responsive to the determination. Computer vision system 102 may comprise computer vision functionality (such as computer vision 110), power analysis 119, and action determination functionality (such as determining actions based on determined shading 120, determined actions based on: (i) determined shading and (ii) determined and/or predicted soiling 122; and determined actions based on determined soiling 124). Computer vision system 102 may comprise one or more computer systems which may include one or more processors and one or more memories, such as illustrated in FIG. 5. Further, computer vision system 102 may include one or more interfaces, such as communication interfaces 111, 121, 123, 125, which may be configured to communicate with one or more external electronic devices. As one example, computer vision system 102 may receive one or more inputs via communication interface 111 for input to computer vision 110, discussed further below. As another example, computer vision system 102 may one or more command signals via communication interfaces 121, 123, 125, as discussed further below. Though depicted in FIG. 1 as separate communication interfaces, fewer or greater communication interfaces may be present within the system. For example, a single communication interface (e.g., an Internet connection, a wireless connection, or the like) may be used by computer vision system 102 to communicate with all external electronic devices. Alternatively, a plurality of communication interfaces may be used by computer vision system 102 to communicate with external electronic devices.

Computer vision 110 may include any one, any combination, or all of: predicate step(s) methodology 112; panel detection methodology 114; shading detection methodology 116; or soiling detection methodology 118. As discussed in more detail below, computer vision 110 may be manifested as one or more computers that executed software on one or more processors in combination with memory storing the executed software. For example, computer vision 110 may use machine learning and/or neural networks in order to teach the system to perform the various functions (e.g., panel detection, shading detection, and/or soiling detection). In particular, computer vision 110 may use machine learning to run analyses of data (such as previous images of solar farms) until it sufficiently discerns distinctions in order to perform the various functions. Various machine learning methodologies are contemplated, including based on one or both of deep learning or a convolutional neural network (CNN). Thus, computer vision 110 may employ machine learning that uses algorithmic models that enable a computer to teach itself about the context of visual data in order to perform the various functions disclosed.

Further, the predicate step(s) methodology 112, the panel detection methodology 114, the shading detection methodology 116, and the soiling detection methodology 118 may be embodied in the software as separate executable programs or as a unitary executable program. As discussed in more detail below, the predicate step(s) methodology 112 may be configured to perform one or more predicate steps in advance of any one, any combination, or all of the panel detection methodology 114, the shading detection methodology 116, and the soiling detection methodology 118. As one example, the predicate step(s) methodology 112 may be configured to perform any one, any combination, or all of: identifying structures within or proximate to the solar farm; analyzing one or more types of images as a trigger to determine whether to perform the masking and/or analysis; performing visual correction; or clipping of a subpart of the image. As discussed in more detail below, the panel detection methodology 114 is configured to analyze one or more images (such as one or more satellite images) in order to identify the solar panels within a respective image. In one or some embodiments, the shading detection methodology 116 is configured to identify shading (e.g., shading from vegetation proximate to the solar panels) within the respective image. In one or some embodiments, the soiling detection methodology 118 is configured to identify one or more solar panels that exhibit soiling and/or identify a degree of soiling on the one or more solar panels.

Computer vision 110 may receive one or more inputs, such as any one, any combination, or all of: one or more images; the wind rose for the solar farm location; solar path for the solar farm location; or one or more soiling models (e.g., one or both of Kimber model or HSU model). As discussed in more detail below, the one or more images may comprise one or more digital satellite images (e.g., visual satellite image or a surface reflectance satellite image). As discussed in more detail below, the panel detection methodology 114, the shading detection methodology 116, and the soiling detection methodology 118 use the inputs listed in FIG. 1.

The outputs of one or both of the shading detection methodology 116 (e.g., the determined shading) and the soiling detection methodology 118 (e.g., whether soiling is present, an extent of soiling, an estimated or predicted soiling in the future) may be subsequently used. In one or some embodiments, the outputs of one or both of the shading detection methodology 116 (e.g., the determined shading) and the soiling detection methodology 118 may be input to power analysis 119. Alternatively, the shading analysis may be solely used to perform one or more actions (e.g., independent or separate from any power analysis, such as power analysis 119).

Power analysis 119 may comprise analyzing power for part or all of the solar farm, such as analyzing power for part or all of the solar farm with regard to one or both of the determined soiling or the determined shading. In one or some embodiments, a power analysis construct, such as a power block, may be used in order to correlate power (such as power generated) to one or both of soiling or shading. For example, the solar panels with part or all of the solar farm may be divided into separate power blocks, with a respective power block being assigned one or more solar panels. In particular, part or all of a first solar panel and part or all of a second solar panel may be assigned to the respective power block. In the instance where an entire solar panel is assigned to the respective power block, the soiling and/or shading determination for that entire solar panel may be assigned to the respective power block. In the instance where only part of a solar panel (such as 40% of the solar panel) is assigned to the respective power block, only part (such as the percentage of the solar panel (e.g., 40%)) of the soiling and/or shading determination for that solar panel may be assigned to the respective power block as a weighted value. Further, the respective power block may be assigned an amount of power generated (e.g., a daily average power (during daylight)). In this way, the respective power block, with amount of power generated and an associated soiling value and/or associated shading value (which may be weighted), may correlate soiling and/or shading with power.

In one or some embodiments, the power analysis may further include a determination of one or both of: (i) an amount of power loss due to shading and/or soiling; or (ii) an amount of power potentially gained if one or more corrective actions are performed (e.g., cleaning solar panels or removing vegetation). As discussed in more detail below, the numbers for the power blocks (e.g., the power generated for a respective power block versus the soiling value and/or shading value) may be analyzed in one of several ways. In one way, a respective power block (e.g., the numbers associated with the respective power block) may be compared over time (e.g., analysis of numbers for a first image versus numbers for a second image taken later in time). Alternatively, or in addition, another way is for the respective power block to be compared with other power block(s) (e.g., analysis of numbers from a first image for the respective power block versus numbers from the first image for other power block(s) in the solar farm).

In particular, the power analysis may determine (i) and/or (ii) at the power block level (e.g., for one or more of the power blocks), at the power block group level (e.g., for one or more different groups of power blocks), and/or at the solar farm level (e.g., across all power blocks on the solar farm). Merely by way of example, in one or some embodiments, the power analysis may determine for one, some, or all power blocks for the solar farm: (i) the power loss due to soiling and/or shading (based on the correlation of power to determined soiling and/or shading values); and/or (ii) the potential power gain due to cleaning solar panels and/or removing vegetation (e.g., a potential reduction in the soiling value and/or the shading value due to cleaning or removing vegetation, respectively, thereby resulting in an increase in the power generated for the respective power block). In practice, the system may perform (i) and/or (ii) for a set of power blocks (such as the top 20 power blocks by amount of power loss in (i) or the amount of potential power gain in (ii)). In this way, a visual output may be generated in order to justify the expense of performing the one or more corrective actions (whether of cleaning or of removing vegetation) versus the power loss and/or power gain. Likewise, as another example, the power analysis may determine for one, some, or all groups of power blocks for the solar farm: (i) the power loss due to soiling and/or shading; and/or (ii) the potential power gain due to cleaning solar panels and/or removing vegetation, and use (i) and/or (ii) in determining whether to perform the one or more corrective actions. In this way, the one or more corrective actions may be performed if the gain (e.g., reduction in power loss and/or the potential power gain) is greater than the costs of the one or more corrective actions (such as at least twice or thrice greater).

In either instance (e.g., based on the power analysis 119 or not), determined actions based on determined shading 120 may comprise one or more actions to perform based on the determined shading, such as any one, any combination, or all of: modification of an image to indicate where and/or in what sequence to remove vegetation; automatic triggering of communications, such as emails, to notify an operator to remove vegetation where and/or in what sequence; automatic vegetation removal where and/or in what sequence. In turn, determined actions based on determined shading 120 may send one or more control signals to electronic device(s) to perform the determined actions based on determined shading 130. Various electronic device(s) to perform the determined actions based on determined shading 130 are contemplated. As one example, responsive to modifying the image to indicate where and/or in what sequence, an electronic device, such as a display, may display the modified image. As another example, responsive to automatically triggering communications, one or more electronic devices may receive the communications, such as a smartphone, a tablet, or the like. As still another example, responsive to triggering automatic vegetation removal, determined actions based on determined shading 120 may send one or more control signals (which may include designations of location(s) and/or indications of the amount of vegetation removal) to device(s) in order for the device(s) to automatically trim or remove vegetation at the designations of location(s)).

In one or some embodiments, the soiling analysis may be solely used to perform one or more actions. For example, determined actions based on determined soiling 124 may comprise one or more actions to perform based on the determined shading, such as any one, any combination, or all of: modification of an image to indicate which solar panels to clean and/or an order of cleaning; automatic triggering of communications, such as emails, to notify an operator to clean the solar panels; automatic control of cleaning devices to automatically clean solar panels in a designated sequence. In turn, determined actions based on determined soiling 124 may send one or more control signals to electronic device(s) to perform the determined actions based on determined and/or predicted soiling 134. Various electronic device(s) to perform the determined actions based on determined and/or predicted soiling 134 are contemplated. As one example, responsive to modifying the image to indicate where and/or in what sequence to clean the solar panels, an electronic device, such as a display, may display the modified image. As another example, responsive to automatically triggering communications, one or more electronic devices may receive the communications, such as a smartphone, a tablet, or the like. As still another example, responsive to triggering automatic cleaning, determined actions based on determined soiling 124 may send one or more control signals (which may include designations of location(s) and/or designations of solar panels) to device(s) in order for the device(s) to automatically clean at the designations of location(s)) or the designated solar panels in a designated sequence).

In one or some embodiments, the shading analysis and the soiling analysis may be used in combination to perform one or more actions. For example, determined actions based on: (i) determined shading and (ii) determined and/or predicted soiling 122 may comprise one or more actions to perform based on the determined shading, such as for one or both of: performance characterization of the solar farm; or modification of layouts of future solar farm site(s). In turn, determined actions based on: (i) determined shading and (ii) determined and/or predicted soiling 122 may send one or more control signals to electronic device(s) to perform the determined actions based on both: (i) determined shading and (ii) determined and/or predicted soiling 132. Various electronic device(s) to perform the determined actions based on determined and/or predicted soiling 132 are contemplated. As one example, responsive to the performance characterization, an electronic device, such as a display, may display the performance characterization. As another example, the analysis may result in modifications of the model, which, when thereafter executed on a computer, modify the layouts of future solar farm sites.

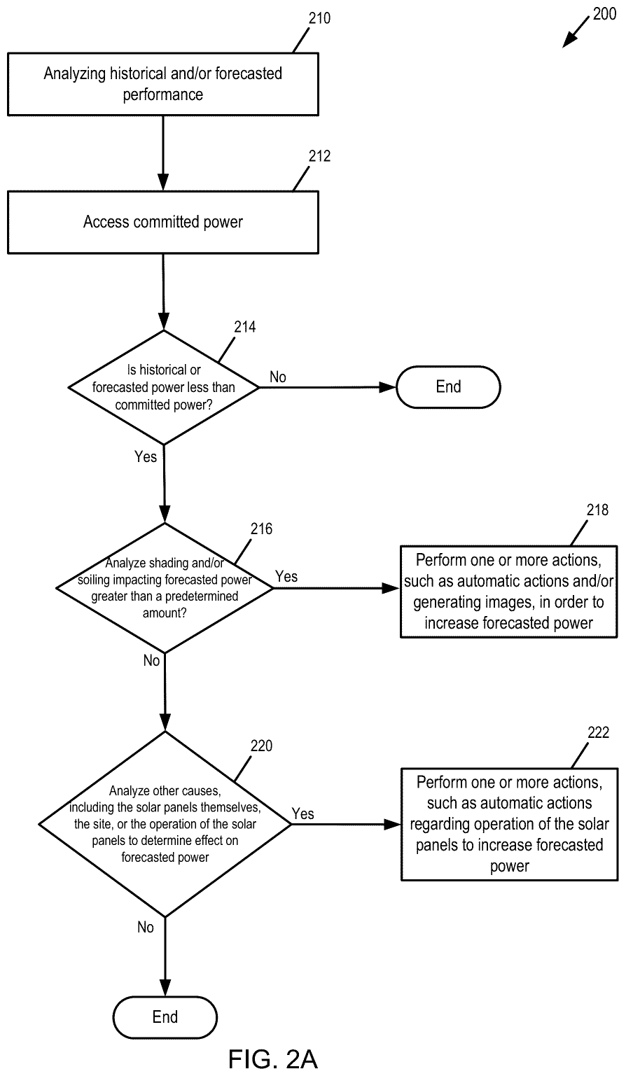

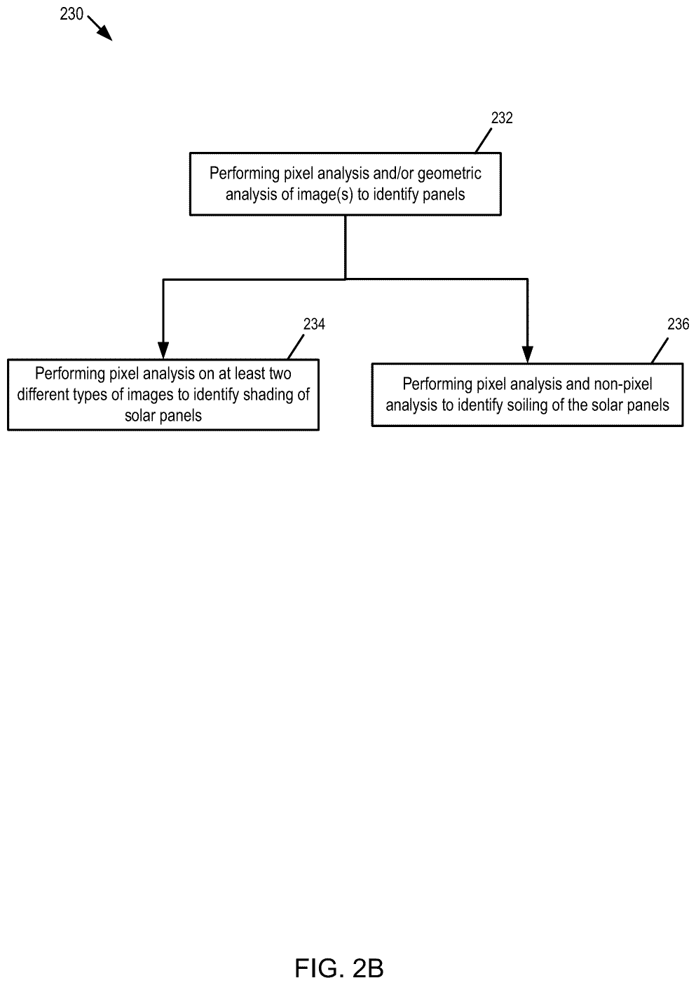

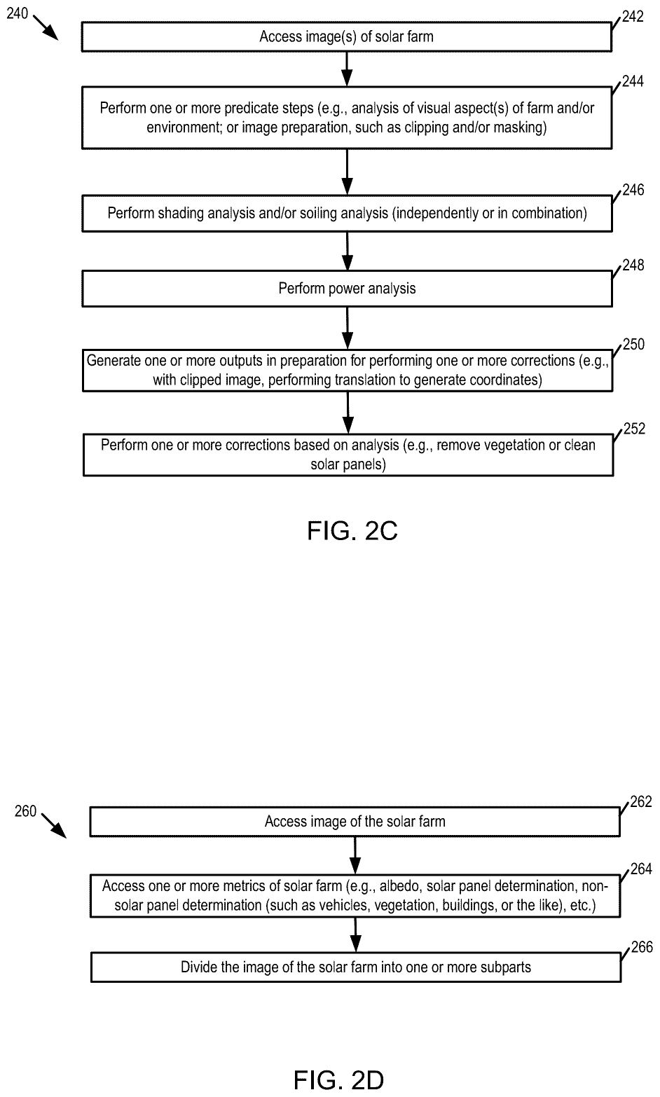

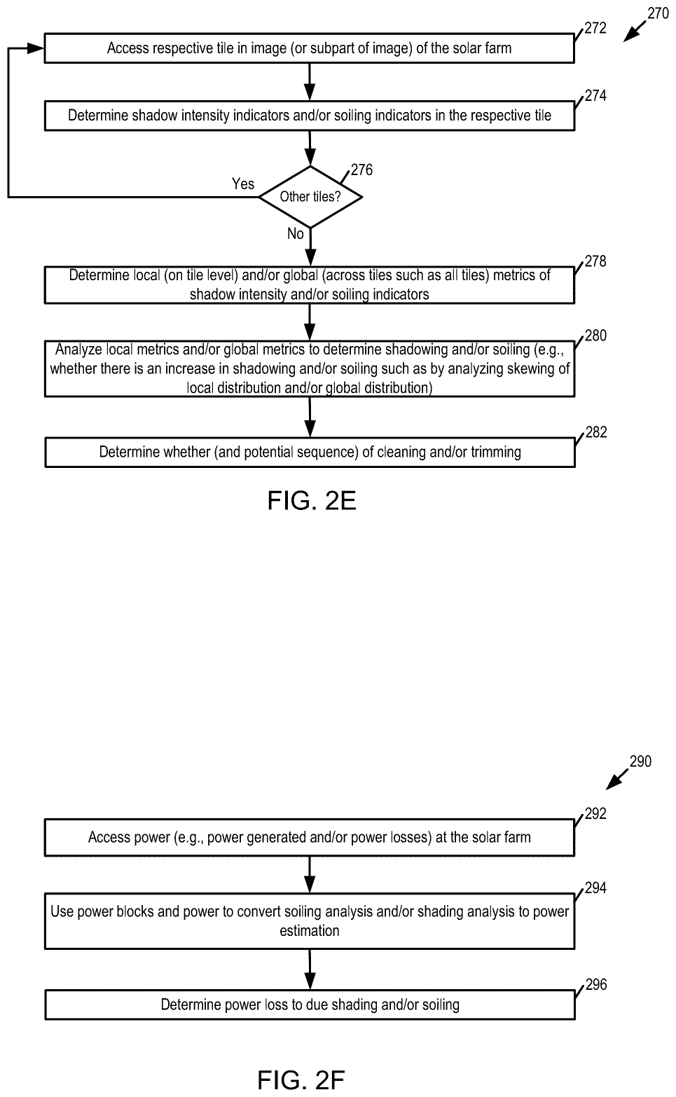

FIG. 2A is a flow diagram 200 for analyzing historical or forecasted performance and further analysis to improve the performance. As discussed above, energy companies may engage in agreements to provide power, such as by using solar farms. Operation of the solar farms may be predicated on whether the power provided by the solar farms meets (or is forecasted to meet) what was committed to in the agreements. As such, at 210, the historical and/or forecasted performance may be analyzed. At 212, the committed power may be accessed (e.g., previously committed to be generated by contract; committed to be generated in real-time; future commitments of energy). For example, a solar farm operator may, in real-time (e.g., less than 1 minute, less than 5 minutes, etc.) or near real-time (e.g., less than 1 hour, less than 1 day, less than 1 week, etc.) may automatically generate a bid (e.g., automatically send a communication to an exchange or the like, with the communication including information as to the amount of energy committed, the cost of the energy, and the timing that the energy will be sent) to commit energy based on such analysis of the forecasted generated power. Responsive to the bid being accepted, the system may automatically commit the energy (e.g., automatically control one or more switches or the like in order to route the power). In this regard, any one, any combination, or all of the analysis, the bidding, or the commitment of energy may be automatically performed. Alternatively, the automatic process (e.g., analysis, bidding, and commitment of energy) all need not be performed in real time. Rather, one, some, or none of the steps may be performed other than in real time. For example, the analysis may be performed earlier whereas the bidding/commitment of energy may be performed in real time.

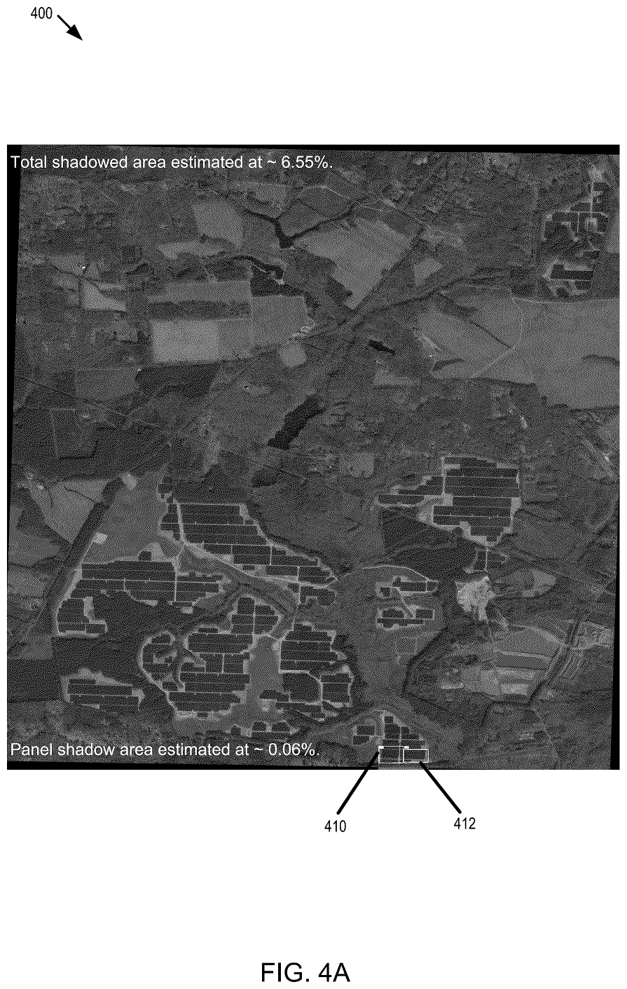

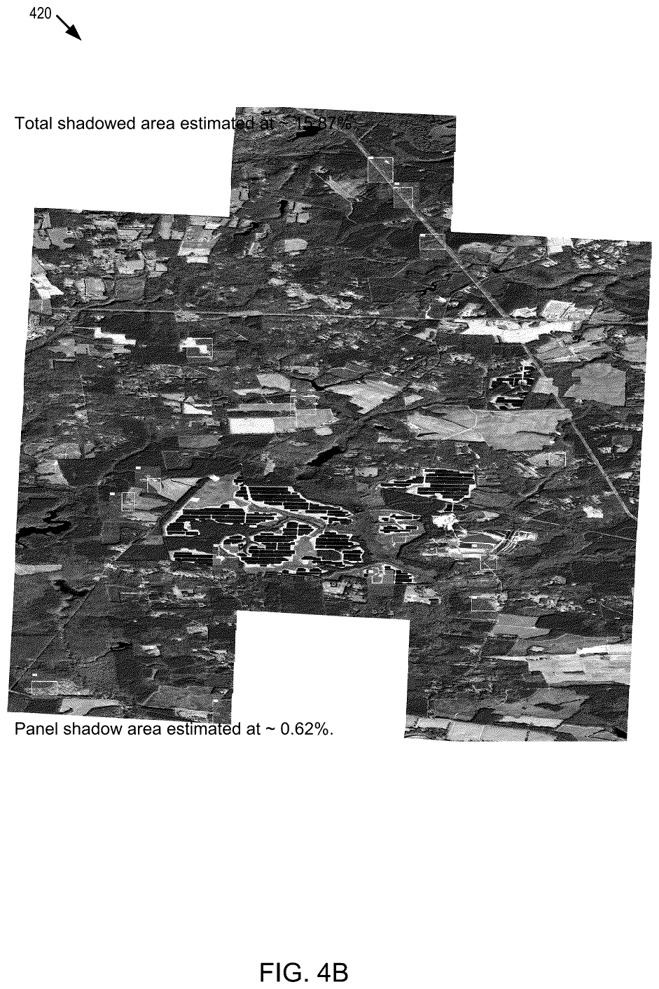

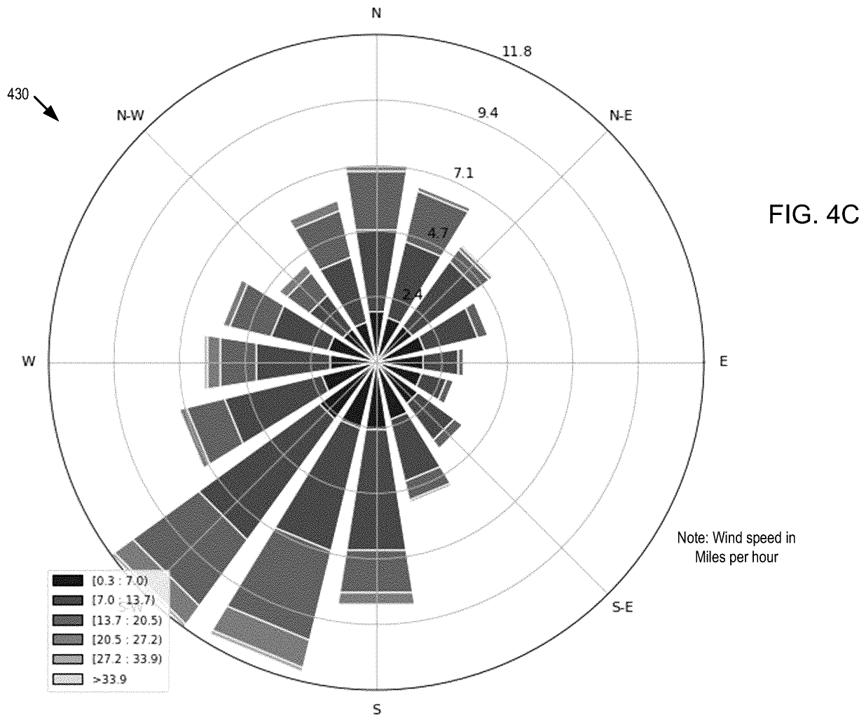

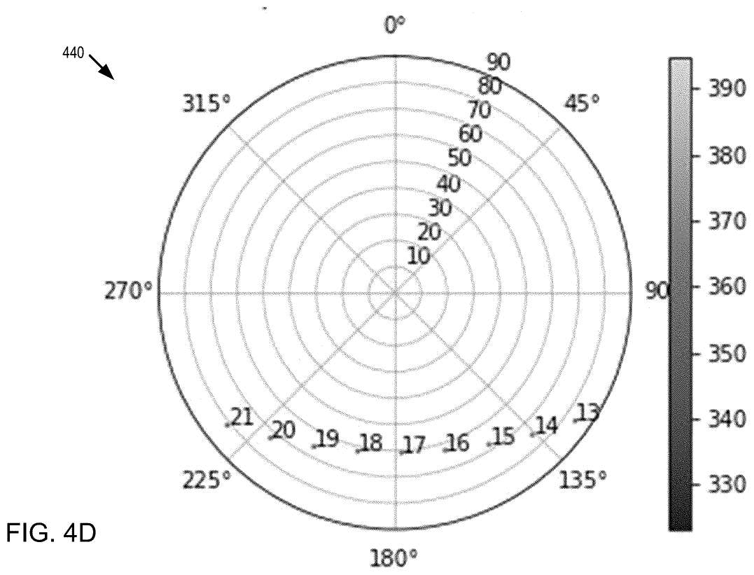

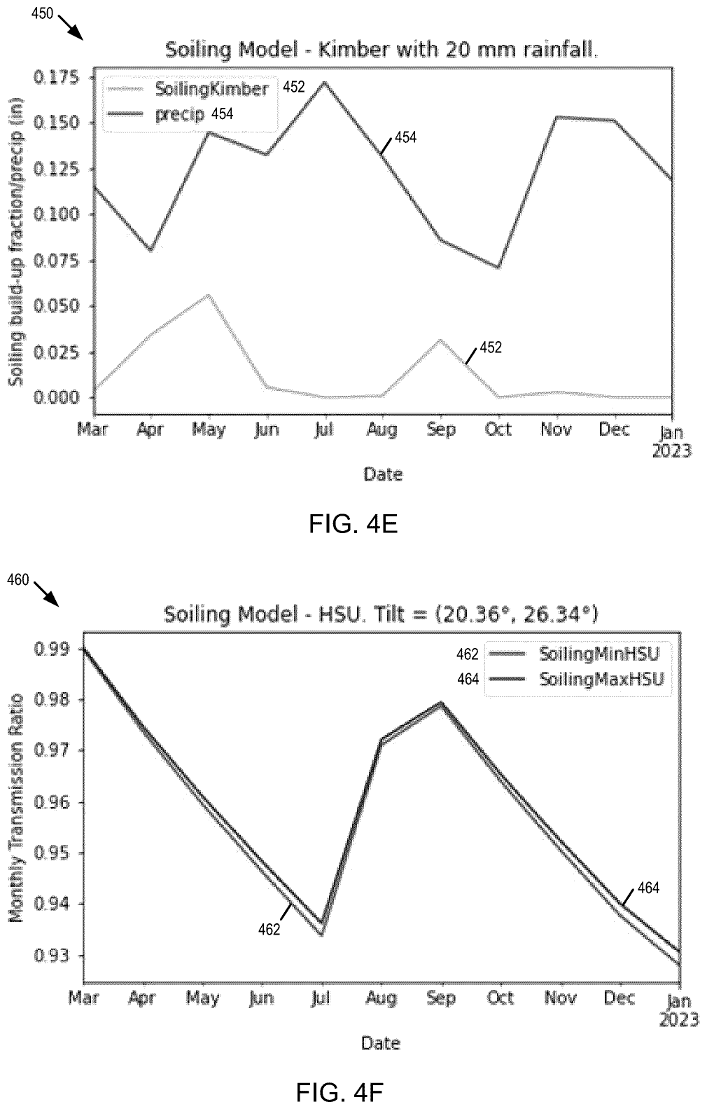

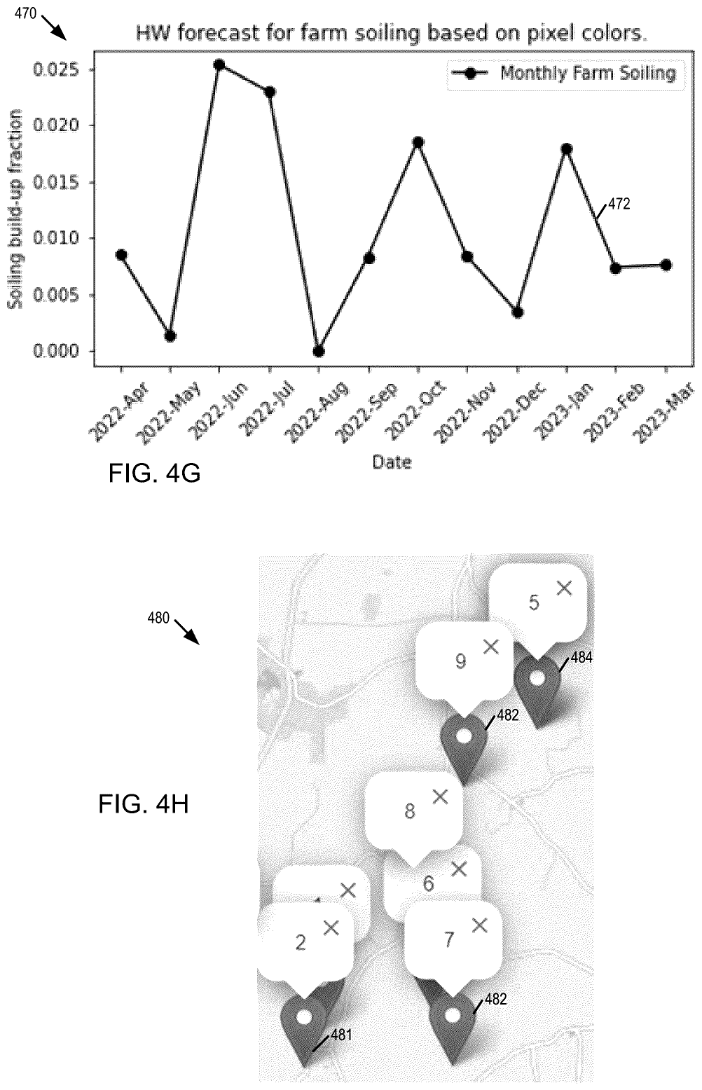

At 214, it is determined whether the historical or forecasted power is less than the committed power. If not, flow diagram 200 ends. If so, one or more reasons for the historical or forecasted power being less may be investigated. For example, at 216, shading and/or soiling may be analyzed to determine whether they impact the forecasted power greater than a predetermined amount. As one example, if the impact of soiling and/or shading is greater than a predetermined amount, at 218, one or more actions may be performed, such as performing automatic action(s) (e.g., automatic cleaning) or generating images (see FIG. 4H) in order to increase the forecasted power. As another example, if the impact of soiling and/or shading is negligible or less than a predetermined amount, other causes may be investigated. For example, at 220, other causes, including the solar panels themselves, the site, or the operation of the solar panels, may be analyzed to determine effect on forecasted power. If the effect on the forecasted power is greater than a predetermined amount, at 222, one or more actions may be performed, such as one or more automatic actions (e.g., changing the tilting of the solar panels) in order to increase the forecasted power. As one example, the automatic tilting of the panels may be automatically modified based on the analysis. In particular, the automatic tilting of the panels may be subject to a range of tilting (e.g., a tilt angle and a maximum tilt angle). The analysis may determine to automatically modify the range of tilting in order to increase the forecasted power (e.g., increase or decrease the range). The analysis may identify the optimal tilting operating range, accounting for operating conditions, such as the benefits of greater tilting to roll of the dirt versus greater direction of the solar panel away from the sun, thereby optimally balancing a variety of factors. As another example, placement of the panels (either in a newly configured solar farm or in the existing solar farm subject to analysis) may be modified based on the analysis.

FIG. 2B is a higher-level flow diagram 230 for determining both of shading and soiling of the solar panels. At 232, pixel analysis and/or geometric analysis is performed in order to identify locations of one or more solar panels in the satellite image. As discussed in more detail below, one example of the geometric analysis comprises identifying any one, any combination, or all of edge, contour, line or corner in order to identify the solar panels within the satellite image. In turn, the identification of the panels may be used for one or both of the shading analysis or the soiling analysis. As one example, at 234, shading analysis comprises performing pixel analysis on at least two different types of images, such as a visual satellite image or a surface reflectance satellite image. As another example, at 236, soiling analysis comprises performing pixel analysis and non-pixel analysis in combination to identify soiling (whether soiling is present on a respective solar panel and/or the extent of soiling on the respective solar panel).

FIG. 2C is a flow diagram 240 for determining one or both of shading or soiling, performing a power analysis, and performing one or more corrections. At 242, one or more images of the solar farm are accessed. At 244, one or more predicate steps may optionally be performed. As discussed above, various predicate steps are contemplated, such as one or both of: analysis of one or more aspects of the solar farm; or one or more image preparation steps. As one example, various aspects of the solar farm are contemplated, such as any one, any combination, or all of the following: vegetation of the solar farm; movable objects (e.g., vehicles) on the farm; stationary object (e.g., buildings) on the farm; or visual aspect(s) of the farm (e.g., albedo); etc. In one or some embodiments, these aspect(s) of the solar farm may be used in one or more other predicate steps, such as for any one, any combination, or all of: clipping; masking (e.g., such as masking based on albedo, masking based on solarization, and/or gamma correction); or solar panel identification.

Generally speaking, masking may enhance one or more parts of an image (or a subpart of the image) and/or suppress one or more other parts of the image (or the subpart of the image). For example, masking may suppress the background (e.g., ground) and/or enhancing the foreground (e.g., the area of the panels and the area above the panels, such as foliage). After masking, in the case of soiling, the computer vision system may better identify whether soiling exists on the solar panels, with this identification potentially being contingent on the albedo being a low value. Conversely, if the reflectance that emanates from the background (which may be the ground) is strong, then these two colors may tend to merge (e.g., the color on the panels in the foreground and the color of the ground in the background). In such a case (where the albedo is higher), If the albedo is high, the system may perform one or both of: (1) using the raw image as is (e.g., unmasked); or (2) invert the masking process (thereby suppressing the foreground and enhancing the background). Thus, if the albedo (which may be an indicator of ground reflectance) is strong or higher, then the computer vision system may be less able distinguish between the reflectance emanating from the solar panel and the reflectance emanating the ground because they may both reflect the same (or similar) wavelength(s). However, where the albedo is lower, applying a mask may assist the computer vision system to better distinguish between soiled and non-soiled solar panels since the contrast between colors may be clearer. In this way, masking may be dynamically performed based on the visual aspect.

As such, the visual aspect (such as albedo) may be used in one or more contexts, such as for any one, any combination, or all of clipping, masking, or pixel analysis. In one or some embodiments, albedo may comprise an indicator of the fraction of sunlight that is diffusely reflected by a body. It may be measured on a scale from 0 (corresponding to a black body that absorbs all incident radiation) to 1 (corresponding to a body that reflects all incident radiation). The proportion reflected may not only be determined by properties of the surface itself, but may also be determined by the spectral and angular distribution of solar radiation reaching the Earth's surface. These factors may vary with atmospheric composition, geographic location, and time (such as based on the position of the sun).

As one example, for sites/locations with dominant albedo (e.g., albedo as the fraction of sunlight that is diffusely reflected by a body), background suppression/foreground enhancement may be needed for better image analysis. For such sites, a foreground mask acts as the base for evaluation, as discussed further below. As another example, albedo may impact the type of masking performed, with masking providing an opportunity to better visualize when visual spectrum is indecisive. In this regard, in one or some embodiments, if albedo is low, a foreground mask may be used to suppress background and with the masked image being used. If albedo is high, a background mask may be used to suppress foreground and the masked image or the mask (foreground or background) itself may be used as the image to be analyzed.

Albedo may be determined in one of several ways. In one way, the solar farm may have an albedo meter, which may comprise a sensor configured to generate an indicator of how much the albedo is. Alternatively, or in addition, albedo may be determined in the absence of the albedo meter by analyzing the result of masking (e.g., if after masking, the system is unable to distinguish the foreground from the background, the system may conclude that the albedo is high; so that, comparison of the unmasked image with the masked image indicating a difference less than a predetermined amount may indicate a higher albedo).

Thus, in the context of soiling, in one or some embodiments, if the background-suppressed masked image is used, soiling may be estimated by a ratio of non-dark pixels to total number of pixels, provided the panel filter is passed. If a foreground-suppressed masked image is used, soiling may be estimated by ratio of non-dark shaded pixels of the dominant hue to total number of pixels, again provided the panel filter is passed. Such masking steps seek to identify the dominant colors shown and act as a predicate step prior to soiling analysis. As discussed further below, soiling analysis identifies different dominant colors based on the albedo, with a lower (such as less than a predetermined amount or absence of) albedo having an associated a first spectrum indicative of soiling and a higher albedo (e.g., greater than a predetermined amount) having an associated second spectrum indicative of soiling.

Further, in the context of shading, generally speaking, solar panels may have a darker hue (independent of soiling or shading). In this regard, an unshaded solar panel and a shadowed panel may reflect similar colors in the darker spectrum. It is further noted that shading may be due to inter-panel shading, in which a solar panel position (e.g., from tilting) may cause a shadow on an adjacent panel, discussed further below. Nevertheless, masking, such as suppressing the foreground and enhancing the background, may still present (after masking) darker colors for both the unshaded solar panel and the shadowed panel, but with more marked differences. For example, after masking, the unshaded solar panel may indicate a less dark hue than the shadowed panel. So that, when performing the pixel-based shading analysis, the less dark hues may be segmented from the darker hues that indicate shading. Thus, a similar type of masking (enhancing/de-emphasizing the foreground/background) may be performed in preparation for the shading analysis and the soiling analysis. However, the particular type of masking may, in one or some embodiments, be at least partly different (such as the exact opposite in at least one aspect). For example, in preparation for the soiling analysis, under certain albedo values, the foreground may be enhanced and the background may be suppressed. Conversely, in preparation for the shading analysis, under certain albedo values, the background may be enhanced and the foreground may be suppressed.

As discussed above, clipping or trimming the underlying image may be performed in order to generate one or more subparts of the underlying image. Clipping or trimming may focus on an AOI or ROI and may: (i) reduce computational requirements; and (ii) increase accuracy in the estimation or interpretation of soiling and/or shading. In one or some embodiments, a single subpart of the underlying image may be generated. Alternatively, multiple subparts of the underlying image may be generated. In generating the multiple subparts of the underlying image, one or more factors may be used, including one or both of: portion(s) of the solar farm (e.g., identification of solar panels within the underlying image, with clipping to include the identified solar panels; identification of vehicles, roads, vegetation, etc. with clipping to at least partly exclude such things); visual aspect(s) (e.g., identification of different albedo levels across the underlying image, with clipping different subparts corresponding to the subparts having albedo levels that are different by at least a predetermined amount).

At 246, shading analysis and/or soiling analysis may be performed (such as independently of one another or at least partly in combination). Merely by way of example, the shading analysis may differentiate between the different types of dark colors in the image, such as the solar panels themselves (with darker coloring in the absence of soiling or shading), solar panels shaded due to vegetation, and solar panels shaded due to inter-panel shading. To accomplish this, the shading analysis may be configured to analyze multiple types of images, such as a visual image and a surface reflectance image (which may indicate anything in the foreground being more clearly visible and portions in the background as false colored, such as green vegetation being illustrated with a reddish color). As discussed herein, the shading analysis may use the one or more images in order to establish a range of potential shading as part of the shading analysis. Similarly, the soiling analysis may be configured to determine whether (and the extent of) soiling on solar panel(s).

At 248, a power analysis may optionally be performed. As discussed above, one or more metrics, such as power blocks, may be used to correlate the shading and/or soiling analysis with the power analysis, thereby effectively providing a transition from the soiling/shading world to the power world. As discussed above, a respective power block may include one or more solar panels and/or may include parts of one or more solar panels. The soiling value and/or the shading value associated with the respective power block may be dependent on the soiling values or the shading values for the one or more solar panels assigned to the respective power block and/or may be dependent on the weighting of the soiling values or the shading values from the parts of the one or more solar panels assigned to the respective power block (e.g., if only 40% of a particular solar panel is assigned to the respective power block, 40% of the soiling value or the shading value is assigned to the respective power block). As discussed above, the power analysis may include analyzing power (such as power loss) due to both soiling and shading in combination (e.g., power loss attributed to both shading and soiling as one example of the in combination power analysis). In particular, the power blocks may be analyzed in any one, any combination, or all of: (i) analyzing a respective power block for different iterations; (ii) analyzing the respective power block with respect to other power block(s); (iii) analyzing the respective power block(s) for shading and soiling in combination. The result of the power analysis may be used to determine whether (or how much) additional power may be generated by at least partly correcting for: soiling by cleaning the solar panel(s) assigned to the certain power block(s) and/or shading by at least partly removing vegetation proximate to the solar panel(s) assigned to the certain power block(s).

At 250, one or more outputs may be generated in preparation for performing one or more corrections in order to correct for soiling and/or shading. As one example, once the system identifies the solar panel(s) for cleaning and/or the vegetation for removal, the system may generate one or more outputs in order to perform the one or more corrections. In one particular example, the system may generate one or more images (which may include an underlying image, such as the original satellite image or a third-party image) and may include information indicative of any one, any combination, or all of the following: location information (e.g., latitude/longitude; GPS coordinates; etc.); soiling and/or shading information; or sequence information (e.g., an indication of the sequence of cleaning or removing vegetation).

Thus, in one or some embodiments, location information (such as a graphic with pin, icons or the like indicating the location information) may be generated for the one or more corrective actions, such as cleaning the solar panel(s) and/or removing vegetation identified at 246 and/or 248. As discussed herein, a tile-by-tile analysis may indicate which solar panels are subject to cleaning or which vegetation adjacent to the solar panels are subject to removal. Responsive to identifying a respective tile (and/or a solar panel within the respective tile) for corrective action, one or more actions may be performed in order to identify the location information for the respective tile (or the solar panel within the respective tile). As one example, when the system analyzes the image as a whole, and when the image has metadata indicating absolute positioning for at least one point on the image, a first translation may be performed in order to identify, in the absolute positioning, the location of the respective tile (or the solar panel within the respective tile). Thereafter, a second translation may be performed in order to generate the display (e.g., translating the absolute positioning of the respective tile (or the solar panel within the respective tile) into another form, such as for a Keyhole Markup language Zipped (KMZ) file or a Keyhole Markup Language (KML) file, which in turn may be viewed in various geographic information system (GIS) applications, such as Google Earth). As another example, when the system analyzes a subpart of the image, and when the image has metadata indicating absolute positioning for at least one point on the image, an initial additional translation(s) may be performed including from the respective tile (or the solar panel within the respective tile) to the adjusted location for the subpart of the image (e.g., the upper lefthand corner of the subpart of the image) and to the adjusted location for the whole image (e.g., from the upper lefthand corner of the subpart of the image to the upper lefthand corner of the whole image). In this way, the translations may effectively translate the location from the tile where the corrective action is to occur to the origin of the ROI, and translate from the origin of the ROI to the origin of the entire image (which the metadata may indicate according to absolute positioning).

Merely by way of example, the system may perform a geo-transform on the image, comprising a transformation from the image coordinate space (e.g., row, column or pixel, line) to the georeferenced coordinate space, such as projected or geographic coordinates In particular, 6 coefficients (e.g., x-coordinate of the upper-left corner of the upper-left pixel, w-e pixel resolution/pixel width, row rotation, y-coordinate of the upper-left corner of the upper-left pixel, column rotation, and n-s pixel resolution/pixel height) may be transformed into georeferenced coordinate space (e.g., x_geo; y_geo).

At 252, one or more corrections ma be performed based on the analysis and/or based on the one or more outputs generated at 250. As one example, the one or more outputs may comprise instructions to automatically clean a predetermined set of solar panel(s). As another example, the one or more outputs may comprise a graphic with pin, icons or the like indicating the location information, sequence information, and other data to assist operators in performing the corrective actions.

FIG. 2D is a flow diagram 260 for clipping an image of the solar farm based on one or more metrics of the solar farm. At 262, one or more images of the solar farm are accessed. At 264, one or more metrics of the solar farm are accessed. As discussed above, various metrics are contemplated, such as albedo (or the like), solar panel determination, non-solar panel determination (such as vehicles, vegetation, buildings on or proximate to the farm, roads, or the like). The one or more metrics may be analyzed in order to divide the image of the solar farm into one or more subparts at 266 (such as a single subpart or multiple subparts). As one example, responsive to determining that different parts of the farm have different albedo levels (e.g., a first albedo value in a first part of the solar farm is less than a predetermined value and a second albedo value in a second part of the solar farm is greater than the predetermined value or greater than a second predetermined value), the image of the solar farm may be divided so that the first part of the solar farm is in a first subpart and the second part of the solar farm is in a second subpart. In this way, different masking and/or different pixel-based analysis may be performed on the different subparts. As another example, the image may be divided into different subparts in order to include solar panels and/or to exclude vehicles, vegetation, buildings, roads, or the like.

FIG. 2E is a flow diagram 270 for determining soiling and/or shadowing tile-by-tile in an image or a subpart of the image. As discussed above, an AOI or a ROI may be divided into a plurality of tiles. At 272, a respective tile in the image (or in the subpart of the image) of the farm is accessed.

At 274, shadow intensity indicator(s) and/or soiling indicator(s) in the respective tile are determined. With regard to the respective tile, we may identify whether there is at least a part of a solar panel with the respective tile. As discussed herein, the solar panel(s) may be identified via a geometric analysis using identification of lines, corners, and the like. Responsive to identifying solar panel(s) with the respective tile, a pixel-based analysis may be performed for one or both of soiling or shading in order to determine the soiling indicator(s) or the shadow intensity indicator(s), respectively. As discussed above, in one or some embodiments, albedo may be used to determine the pixel values (or pixel ranges) for the pixel-based analysis.

As one example, with regard to soiling, lower albedo may result in the pixel-based analysis using a two-bin process, dividing pixels between darker pixels (e.g., a range of darker pixels from (0, 0, 0) to (R, G, B), where R, G, B may be less than a certain amount, such as 40) and lighter pixels with the lighter pixels being indicative of soiling). Conversely, higher albedo may result in the pixel-based analysis having different bins (e.g., different numbers of bins and/or different colors associated with the bins) than for lower albedo. For example, with regard to higher albedo, in one or some embodiments, the bins are not divided into lighter and darker color bins but other defined colors (e.g., gray (and all of its shades), yellow (and all of its shades), brown (and all of its shades), red (and all of its shades), or a combination of any of these colors). In one or some embodiments, the colors may be predefined regardless of location of the solar farm. Alternatively, the colors may be selected (e.g., manually or automatically) dependent on the location of the solar farm to indicate the specific type of colors indicative of soiling at the location. In this regard, the selection of the subset of the colors that are indicative of soiling may be based on an understanding of soiling chemistry.

As one example, with regard to shading, after identifying the solar panel(s) with the respective tile, albedo may be used for the pixel-based analysis. Though, in one or some embodiments, the bins for the shading analysis are different from the bins for the soiling analysis, as discussed above.

At 276, it is determined whether there are other tiles to analyze. If so, flow diagram 270 loops back to 272. If not, flow diagram proceeds to 278. At 278, metrics (alternatively termed indicators) for shadow intensity and/or soiling are determined at the local level (e.g., on the tile level) and/or on the global level (e.g., across a plurality of tiles, such as all tiles in the ROI). At 280, the local and/or global metrics may be analyzed in order to shadowing and/or soiling.

Various metrics, on the local level and/or the global level, are contemplated, including any one, any combination, or all of absolute numbers (e.g., number of pixels in respective bins), averages, distributions, or the like. Further, the metrics may be analyzed in order to determine trends on the local level and/or the global level.

As a general example, the system may determine on a global level the soiling/shading of the solar farm (such as a certain percentage of shading and/or soiling on a given day) to determine if there's a trend and/or to generate an indication of the probability of soiling and/or shading at the solar farm. In this regard, one metric may comprise the probability of soiling and/or shading. Alternatively, or in addition, the system may determine on the local level (e.g., individual solar panels and/or individual tiles) metrics, including trends of soiling and/or shading, and/or trends (such as downward trends) with regard to power generation at the solar farm, discussed further below.

More specifically, with regard to shading, three metrics may comprise shadow (e.g., an indication of the probability of finding a shadow, which may be represented as a percentage of the total number of darker pixels), shadow intensity (e.g., the percentage of true black pixels, which may be different (and narrower than) darker pixels), and distribution (e.g., such as a plot of the values from the smallest RGB to the largest RGB, with the distribution having certain characteristics, such as a gamma distribution, a beta distribution, etc.). In one or some embodiments, one, some, or each metric may be calculated on a local level (e.g., for one, some, or each tile) and/or on the global level (e.g., for all tiles, such as calculating the average shadow across the entire solar farm, the average shadow intensity across the entire solar farm, and/or the average distribution across the entire farm (with the average distribution potentially being gamma, beta, or a combination thereof)).

By way of example, for lower albedo, a threshold of 40 may define the upper limit of the darkness of the pixel (with (0, 0, 0) indicating a perfectly dark pixel) and other pixels with no individual number in the tuple greater than 40 likewise being considered a dark pixel, since light coloring may be considered to result higher than this value. In one or some embodiments, shadow intensity in a respective tile may thus be the total sum of each tuple combination in relation to the total number of colors and may be represented via a histogram.

A specific example for a respective tile is illustrated below:

| RGB index | Number of pixels | Closest color |
|---|---|---|
| (0, 0, 0) | 10 | Black |
| (2, 2, 4) | 5 | Black |
| (10, 20, 30) | 6 | Dark Blue |

In the given example, shadow intensity in the respective tile is 15/21 or 71%. Note that only true reference of dark pixels as indicated by the closest color is used for shadow intensity estimation.

Thus, each respective tile may also have its own distribution based on number of pixels of certain color, with local variation have a best fit statistical distribution. By extension, any respective tile that does not have a true reference in the darker spectrum may have zero shadow intensity. Across each tile, the system may estimate such shadow intensity to generate a global mean and a distribution spanning the solar farm, with the global variation having its own statistical distribution.

As discussed in more detail below, if local distribution skews to the darker spectrum or changes the best fit across a timeline, then shadow effects may have increased in that respective tile alone, indicating that a vegetation trim should be scheduled on trees closest to panels in that respective tile alone (which may not be ideal as the process is expensive and does not contribute significantly to performance gain). Moreover, if global distribution skews to the darker spectrum or changes the best fit across a timeline, then shadow effects may have increased across the solar farm, indicating that a vegetation trim should be scheduled on trees closest to panels in all tiles where the local distribution has also skewed or a changed best fit towards the darker spectrum, which despite being expensive may contribute significantly to performance gain. The sequence of performing the actions, such as the trimming, in descending order, may be determined by the ranking of degree of skew towards the darker spectrum across each candidate tile.

Analyzing the metrics may determine whether, when, or which corrective actions to take. As one example, the metrics may be calculated at predetermined time intervals (from images of the solar farm taken at the predetermined time intervals) in order to determine the trends in the metrics from a quantitative standpoint (e.g., analyzing trends in the shadow intensity) and/or a qualitative standpoint (e.g., analyzing the distribution). In the example of shadow analysis, the shadow intensity for a respective tile may have increased (e.g., from 19% to 23%) indicating vegetation growth in that region. Further, at least one aspect of the distribution may be analyzed, such as the skewness of the distribution. Skewness may comprise a degree of asymmetry in the distribution, such as exhibiting a right (e.g. positive) skewness, a left (e.g., negative) skewness, or no skewness. In one or some embodiments, the skewness of the distribution may be analyzed at different time periods (such as over different days, weeks, etc.) for trends. In one example, in the context of shading, skewness toward the right direction (resulting in the distribution tilting left) may indicate an increase in darkness. In another example, skewness remaining the same may indicate no change in the shading profile. In yet another example, in the context of shading, skewness toward the left direction (resulting in the distribution tilting right) may indicate a decrease in darkness (such as an effect from trimming vegetation).

In one or some embodiments, one or both of the aspect of the distribution (e.g., the skewness of the distribution) or the shadow intensity of respective tile(s) or of the entire solar farm is analyzed to determine whether to perform the one or more corrective actions (e.g., vegetation removal). In one or some embodiments, local indications (e.g., at the tile level) of higher trends in shadow intensity and/or in skewness of the local distribution may be analyzed whether to perform corrective actions. Alternatively, or in addition, global indications (e.g., at the tile group level or for all tiles) of higher trends in shadow intensity and/or in skewness of the global distribution may be analyzed to determine whether to perform corrective actions. In one or some embodiments, corrective actions are performed only responsive to determining higher trends (such as greater than a predetermined trend) in the global indications in shadow intensity and/or in skewness of the global distribution (e.g., towards darker colors). In such an instance, responsive to determining to perform the corrective actions, the local indications of higher trends in shadow intensity and/or in skewness of the local distribution (e.g., towards darker colors) may be analyzed to determine which corrective actions are performed (e.g., which vegetation proximate to predetermined tiles or solar panels are removed and in what sequence based on the tiles or solar panels that indicate higher shadow intensities and/or greater skewness). Alternatively, corrective actions may be performed responsive to determining higher trends (such as greater than a predetermined trend) in the local indications in both shadow intensity and in skewness of the local distribution for a respective local tile.

In one or some embodiments, the metrics associated with soiling analysis are similar to the metrics discussed above for the shading analysis. For example, three metrics may comprise soiling (e.g., an indication of the probability of finding soiling, which may be represented as a percentage of the relevant pixels), soiling intensity (e.g., the percentage of predefined pixels), and distribution (e.g., such as a plot of the values from the smallest RGB to the largest RGB, with the distribution having certain characteristics, such as a gamma distribution, a beta distribution, etc.). Moreover, the analysis of the metrics for the soiling analysis may be similar to the analysis of the metrics discussed above for the shading analysis. For example, local indications (e.g., at the tile level) of higher trends in soiling intensity and/or in skewness of the local distribution may be analyzed whether to perform corrective actions. Alternatively, or in addition, global indications (e.g., at the tile group level or for all tiles) of higher trends in soiling intensity and/or in skewness of the global distribution may be analyzed to determine whether to perform corrective actions. In particular, in one or some embodiments, corrective actions are performed only responsive to determining higher trends (such as greater than a predetermined trend) in the global indications in soiling intensity and/or in skewness of the global distribution. In such an instance, responsive to determining to perform the corrective actions, the local indications of higher trends in soiling intensity and/or in skewness of the local distribution may be analyzed to determine which corrective actions are performed (e.g., which tiles or solar panels are cleaned and in what sequence based on the tiles or solar panels that indicate higher shadow intensities and/or greater skewness). Alternatively, corrective actions may be performed responsive to determining higher trends (such as greater than a predetermined trend) in the local indications in both soiling intensity and in skewness of the local distribution for a respective local tile.

FIG. 2F is a flow diagram 290 of the power analysis. At 292, power, such as power generated and/or power lost, for the solar farm is accessed. At 294, power blocks (discussed above) and the power accessed are used to convert the soiling analysis and/or the shading analysis to power estimation. At 296, the power loss due to shading and/or soiling may then be determined.

Thus, in one or some embodiments, the power analysis, such as illustrated in FIG. 2F, may comprise an integration of the soiling analysis and the shading analysis. In particular, the soiling analysis and the shading analysis may be analyzed in combination with regard to power (such as power loss that may be attributed to soiling and attributed to shading). Alternatively, the power analysis may separately analyze power (such as power loss) with regard to soiling and with regard to shading. Regardless, the power analysis may be used to determine whether (and where) to perform vegetation trimming and/or solar panel cleaning. In this regard, in one or some embodiments, the power analysis may be inserted in between steps 280 and 282 in FIG. 2E.

Thus, in one or some embodiments, one or more parts of the power analysis may be common for soiling and for shading. As one example, the initial power analysis, such as illustrated at 292, may be common to both soiling and shading. As another example, the power block construct, which may be used for power assessment, may likewise be used for both soiling and shading. In this regard, in one or some embodiments, the combination analysis may result in apportionment of the power loss due to each of soiling and shading. By way of example, in the even of a loss of 30 MW at a solar farm, the system may apportion at least a part of the 30 MW loss to soiling and at least a part of the 30 MW loss to shading.

Further, as discussed above, a respective power block (which has a corresponding power output) may be assigned to one or more solar panels and/or one or more parts of solar panels. In turn, the shading estimate and/or the soiling estimate for one or more solar panels and/or one or more parts of solar panels may be assigned to the respective power block. In this way, the respective power block may be analyzed in one of several ways to determine the power loss due to soiling and/or shading (e.g., the respective power block at different times to determine trends for the respective power block and/or the respective power block compared to other power blocks in the solar farm and/or the respective power block as part of the analysis of part or all power blocks on the solar farm). Further, given the power loss, the power gained may be determined from performing the one or more corrective actions, such as cleaning the solar panels and/or removing the proximate vegetation. In one or some embodiments, the power gained may be estimated to be equal to the power loss. For example, power loss due to soiling may be 5 MW. In cleaning the solar panels causing the 5 MW of power loss, the system may estimate that, due to the cleaning, 5 MW may be gained. Alternatively, the power gained may be less than the estimated power loss. In this way, the system may correlate the one or more corrective actions to an increase in energy production (which may thus be used to determine whether the costs of performing the one or more corrective actions are outweighed by the energy benefits.

In one or some embodiments, the power analysis may generate one or more results such as one or both of: (i) commands for automatically controlling one or more devices (e.g., commands to control automatic cleaning of the solar panels in the sequence as determined by the power analysis); or (ii) one or more display outputs (e.g., GUIs) that include any one, any combination, or all of: (1) a map of the solar farm; (2) one or more pins, icons, or the like associated with different sections of the map; (3) location data associated with the pins, icons, or the like (e.g., GPS data for an operations person to guide the operations person to a particular location for cleaning or vegetation clearing); or (4) sequence data indicating to the operations person a sequence of performing the operations. Alternatively, or in addition, any one, any combination, or all of the following maps may be generated: (1) a soiling map indicating by solar panel, by tile, etc. estimated soiling; (2) a shading map indicating by solar panel, by tile, etc. estimated shading; or (3) a power map indicating by solar panel, by tile, etc. estimated power generated and/or power loss due to soiling and/or shading.

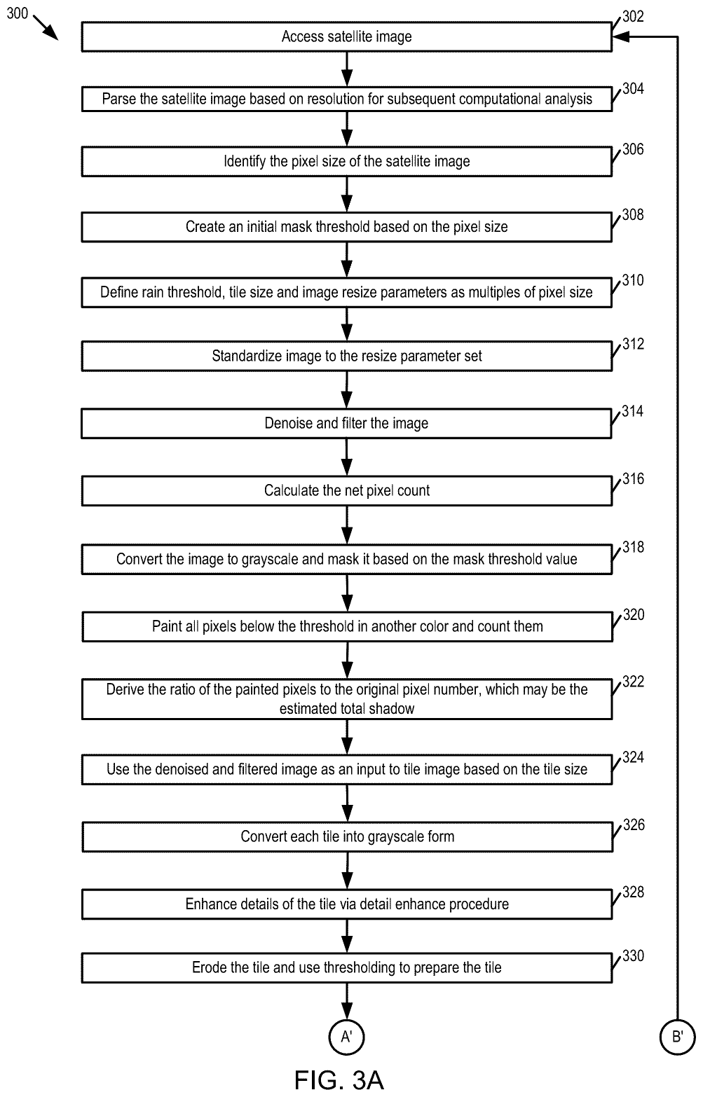

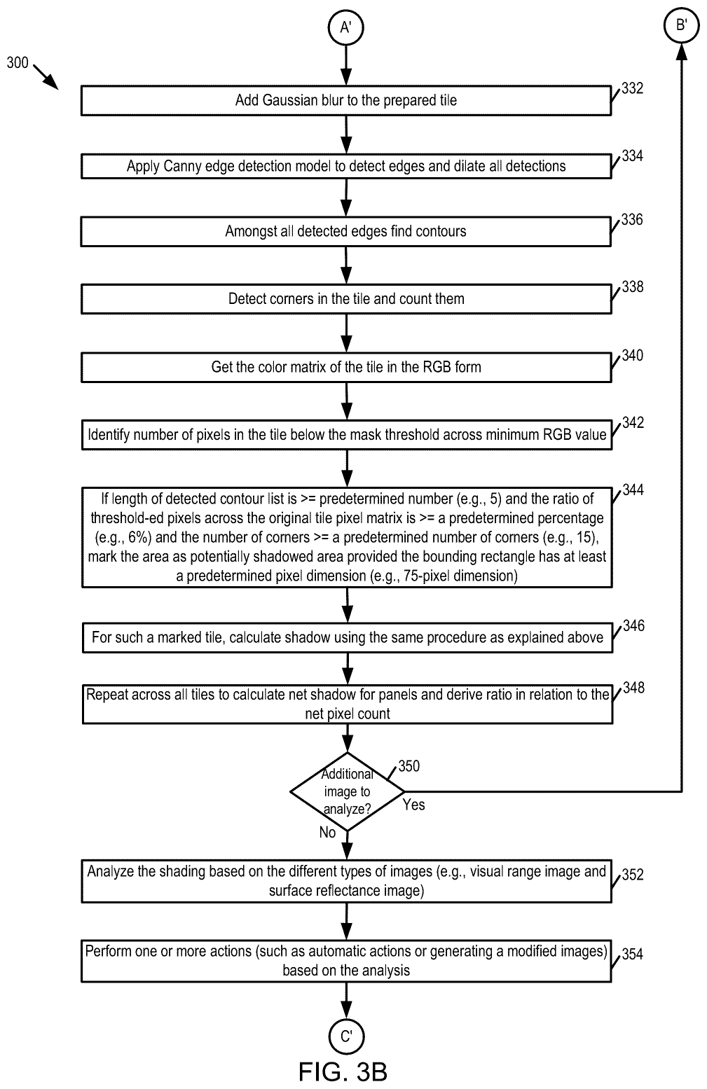

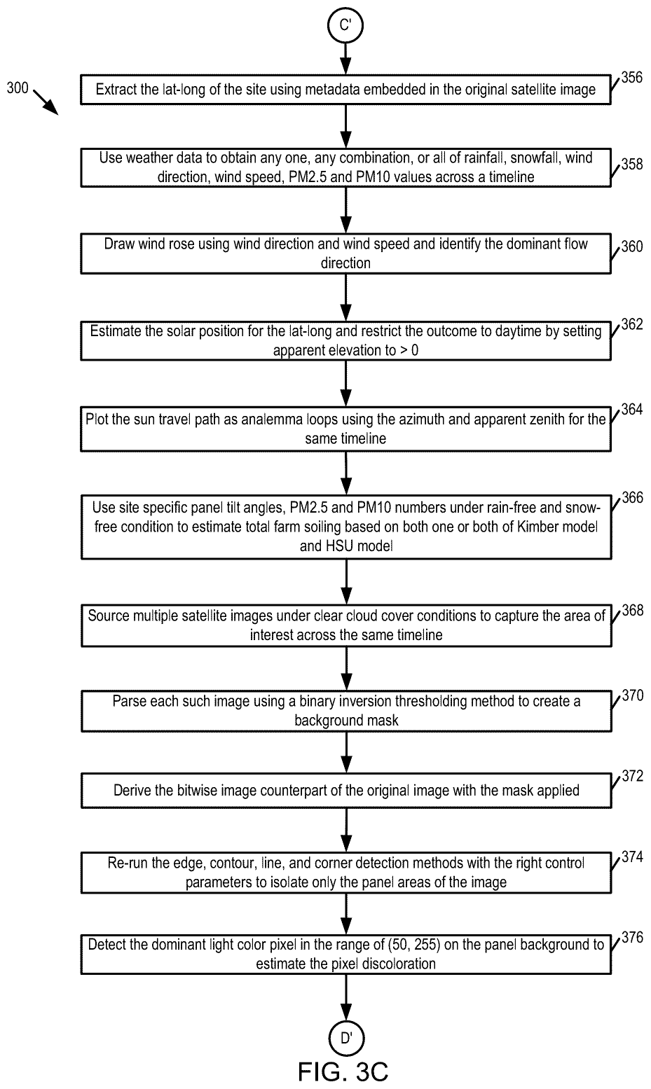

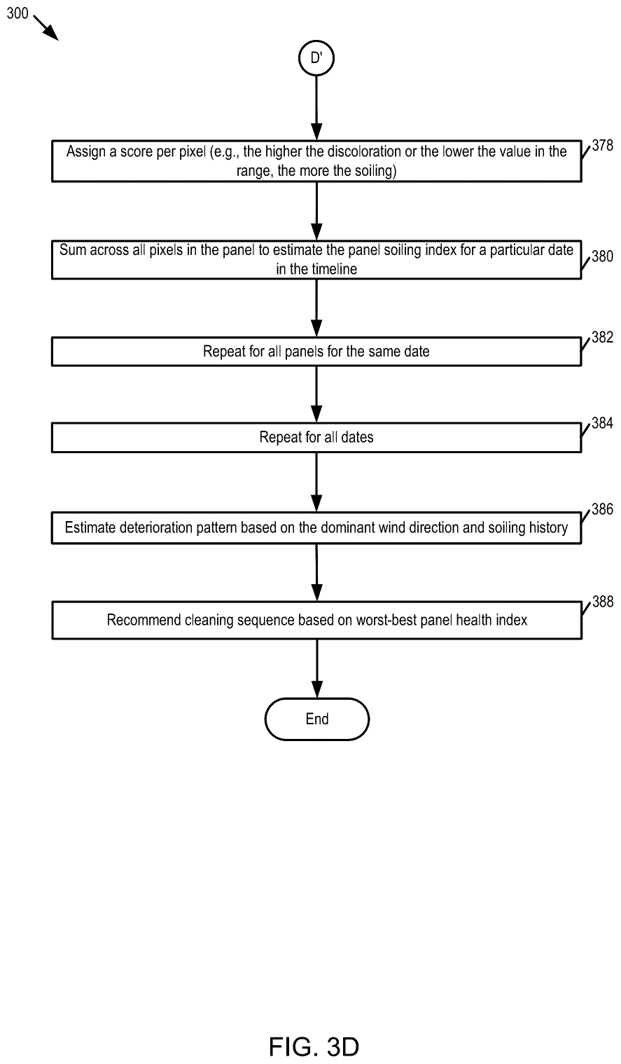

FIGS. 3A-D illustrate a more detailed flow diagram 300 for determining both of shading and soiling of the solar panels. At 302, one or more satellite images are accessed. As discussed above, various satellite images are contemplated, such as the visual satellite image (e.g., a “true” satellite image) or a surface reflectance satellite image. At 304, the satellite image may be parsed based on resolution for subsequent computational analysis. At 306, the pixel size of the image is identified. In this way, the methodology may analyze images of different pixel resolutions (e.g., high resolution versus low resolution).

At 308, an initial mask threshold is created based on the pixel size of the image. In this regard, the mask need only be adjusted based on the pixel size. In one or some embodiments, the Initial mask may be optimized to a threshold of 40, thereby examining pixel values where the colors are less than the value of 40, thereby including colors on the darker spectrum, including dark gray to black. In this way, pixels with values greater than 40 may be suppressed for purposes of the shading analysis. Optionally, pixels with values less than the designated value of 40 may be artificially colored.

At 310, any one, any combination, or all of the rain threshold, the tile size or the image resize parameters are defined as multiples of pixel size. These values may be used in one or both of the shading analysis or the soiling analysis. For example, the rain threshold may be used in the soiling analysis, as discussed further below. At 312, the image is standardized to the resize parameter set. At 314, the image may be one or both of denoised or filtered (e.g., using fastNlMeansDenoising and/or bilateralFilter methods, or the like). As such, denoising may clarify the image and applying the bilateral filter may make the image sharper. At 316, the net pixel count is calculated. At 318, the image is converted to grayscale and masked based on the mask threshold value (see 308). For example, in one or some embodiments, the computer vision code may operate better when analyzing grayscale images.

At 320, some or all of the pixels in the image below the threshold may be painted or designated in another color and counted. At 322, a representation (such as a ratio) of the painted pixels to the original pixel number is generated. This representation is an indicator of the estimated total shadow. At 324, the denoised and/or filtered image is used as an input to tile image based on the tile size. At 326, one, some or each tile is converted into grayscale form. At 328, details of the tile are enhanced via a detail enhance procedure. Various detail enhance procedures are contemplated.

At 330, the tile is eroded and thresholding is used to prepare the tile. For example, An erosion process may suppress parts of the background, such as trees and shrubs, and may enhance the foreground, which includes panels. At 332, Gaussian blur may be added to the prepared tile. At 334, an edge detection model, such as Canny edge detection model, is applied to detect edges and dilate some or all detections. At 336, contours are found amongst some or all of the detected edges. Alternatively, contours may be detected by regular line detections using structural morphology element or by using various methodologies, such as the Hough method. At 338, one or more corners in the tile are detected. For example, the corners may be detected (e.g., using fast feature detector, the Harris method, or Shi-Tomasi procedure) and counted. At 340, the color matrix of the tile is obtained in the RGB form. At 342, the number of pixels in the tile below the mask threshold across minimum RGB value is identified. At 344, if length of detected contour list is ≥a predetermined number (e.g., 5) and the ratio of threshold-ed pixels across the original tile pixel matrix is ≥a predetermined number (e.g., 6%) and the number of corners ≥a predetermined number (e.g., 15), then the area may be marked as a potentially shadowed area provided the bounding rectangle has at least a predetermined dimension (e.g., a 75-pixel dimension). At 346, for such a marked tile, the shadow is calculated using the same procedure as explained above. This may be designated as the tile shadow area. At 348, this may be repeated across some or all of the tiles to calculate a net shadow for panels. Further, the ratio in relation to the net pixel count may be derived. This may be designated as the estimated panel shadow area, which may be represented in one of several ways, such as a percentage.

In practice, multiple types of images may be analyzed in order to determine the estimated panel shadow area. As one example, a visual satellite image may be analyzed in order to generate a respective estimated shadowed panel percentage. As another example, a surface reflectance satellite image may be analyzed in order to generate a respective estimated shadowed panel percentage. These respective estimated shadowed panel percentages may be used in combination, such as to establish a range (e.g., the estimated shadowed panel percentage for the visual image may represent a lower bound of the range and the estimated shadowed panel percentage for the surface reflectance image may represent an upper bound of the range). An example of the surface reflectance image 420 is illustrated in FIG. 4B. As such, at 350, flow diagram 300 determines whether there is an additional image to analyze. If so, flow diagram 300 loops back to 302. If not, at 352, the shading is analyzed based on the different types of images (e.g., visual range image and surface reflectance image) and at 354, one or more actions (such as automatic actions or generating a modified images) are performed based on the analysis. For example, an image (such as satellite image 400) may be modified, such as by overlaying boxes 410, 412 to indicate areas where shading is occurring and optionally for removal of vegetation. In this way, multiple types of images may be analyzed for shadowing.

Thus, a global mask may be created to separate the darker pixels from the lighter pixels. In this regard, the shading algorithm is focused on the darker pixels. This is in contrast to the soiling algorithm, which focuses on lighter pixels. In practice, RBG pixel values for black are 0, 0, 0. The global mask may perform a conversion (e.g., converting the dark panels to a shade of blue). As discussed above, one way to process this image is tile-by-tile. Specifically, for one, some or each tile, the methodology may initially determine areas within a respective tile may potentially contain. In particular, the methodology may examine the areas for one or more geographic features, such as examining the number of edge detections. However, features other than solar panels may exhibit edges. For example, water bodies may appear to have edges as well. In this regard, the methodology is configured to differentiate the geometry of a solar panel versus other bodies, such as a water body. In one or some embodiments, to accomplish this, one or more geometry checks are performed. For example, the methodology may first determine whether a respective feature has “a regular geometry”, such as for a solar panel versus from a water body. The methodology, as described above, may then perform a corner check (e.g., determining whether 2 orthogonal lines meet at a 90° angle indicative of a solar panel versus some other body). In this regard, the geometric analysis may first examine regular geometry and then corners detected. After which, the methodology may examine pixel values. In particular, a darker pixel may indicate a clean panel (e.g., free from soiling) or may indicate a panel that is shadowed. In order to differentiate between a clean panel and a shadowed panel, the ratio of the darker pixels may be examined. For example, at 344, if the ratio is above a predetermined percentage (e.g., 6%), the methodology may indicate that a shadow is present.

Thus, in practice, the methodology may: (i) identify solar panels within the image; (ii) determine whether the solar panel has a predefined color; and (iii) differentiate whether the predefined color in the solar panel is from shading or from a clean solar panel.

At 356, the latitude-longitude of the solar farm site is extracted (e.g., using metadata embedded in the original satellite image). Using the latitude-longitude of the solar farm site, at 358, weather data may be accessed and used to obtain any one, any combination, or all of rainfall, snowfall, wind direction, wind speed, PM2.5 values (indicative of finer particles that are 2.5 microns or less), or PM10 (indicative of coarser particles that are 10 microns or more) values across a timeline. In practice, PM2.5 particles and PM10 particles have different soiling effects on the solar panels. For example, PM2.5 particles may have a higher chemical impact whereas PM10 particles have a higher potential for structural damage to the solar panel.

In one or some embodiments, dominant wind direction(s) may be identified. For example, at 360. wind rose is drawn using wind direction and wind speed to identify the dominant flow direction. An example 430 of the wind rose is illustrated in FIG. 4C. The wind rose may provide a succinct view of how wind speed and direction are typically distributed at the solar farm site.

At 362, the solar position for the latitude-longitude for the solar farm site is estimated and used to restrict the outcome to daytime by setting apparent elevation to >0. At 364, the sun travel path (or solar path) is plotted as analemma loops using the azimuth and apparent zenith for the same timeline. An example of the solar path 440 is illustrated in FIG. 4D. In this regard, 360 and 362 may examine the sun's path to confirm whether the sun was present or whether the weather was overcast.

Separate from (or in addition to) a pixel-based soiling analysis, non-pixel-based soiling analysis may be used. As one example, a Kimber model and/or an HSU model may be used. In particular, at 366, any one, any combination, or all of site specific panel tilt angles, PM2.5 numbers, or PM10 numbers under rain-free and snow-free conditions may be used to estimate total solar farm soiling based on one or both of Kimber and HSU models.

The Kimber model is configured to predict soiling losses as a function of rainfall data and the number of manual cleanings. In particular, the Kimber model uses typical meteorological year data and hourly soiling rates to predict energy production, and comprises a linear model to represent daily system efficiency reduction due to soiling between rainfalls. When daily rainfall exceeds a threshold value, the soiling loss in the Kimber model is assumed to drop to a minimum value. However, the Kimber model does not consider the influence of site-specific environmental parameters such as air quality, wind speed, and humidity. An example of a plot 450 for the Kimber model is illustrated in FIG. 4E illustrating the soiling Kimber estimate 452 and the precipitation 454, with the plot illustrating the soiling buildup fraction/precipitation over the illustrated period.

The HSU model is configured to predict soiling losses while accounting for seasonality and varied climates where relevant to set realistic performance and revenue expectations for solar PV projects. HSU model estimates soiling losses based on particulate matter concentration (PM10, PM2.5), rainfall, wind speed, ambient temperature, and tilt. An example of a plot 460 for the HSU model is illustrated in FIG. 4F, with the plot illustrating the monthly transmission ratio (with 100% transmission indicating no soiling) over the illustrated period, with 2 different a minimum transmission ratio 462 and a maximum transmission ratio 464. As shown, the transmission ratio increases, such as July-September 2023, which may indicate partial cleaning and/or rainfall that partially cleans the panels. In this regard, the Kimber model may indicate whether there is soiling. In contrast, the HSU model may indicate a change in the transmission ratio.

At 368, multiple satellite images under clear cloud cover conditions may be sourced in order to capture the area of interest across the same timeline. At 370, one, some, or each of the multiple images may be parsed using a binary inversion thresholding method to create a background mask. At 372, the bitwise image counterpart of the original image may be derived with the mask applied.

As discussed above, the shading analysis and the soiling analysis may commonly perform the pixel and/or geometric analysis to identify the solar panels within a respective image. For example, at 374, the edge, contour, line, and corner detection methodology, discussed above, may be re-executed with the predetermined control parameters (e.g., flat; rectangular; etc.) to isolate only the panel areas of the image.

At 376, the dominant light color pixel in a predetermined range (e.g., in the range of (50, 255)) on the panel background is detected to estimate the pixel discoloration. For example, pixels having darker values may be reflected as a certain color (e.g., as blue) whereas other pixels whose values may indicate dirt may be identified. One definition of values as indicating dirt is as follows: 60.78% red; 46.27% green; 32.55% blue. In one or some embodiments, dirt need not comprise a fixed value, but in ranges, such as from light orange/brown to dark orange/brown. Various ranges of values are contemplated (e.g., yellow: 35,255,255 to 25, 50, 70; orange: 24,255,255 to 10, 50, 70; and brown: 10, 100, 20 to 20, 255, 200). In this regard, masks may be used to filter the image for values in the respective ranges (e.g., a post-mask value=1 indicates that the pixel value in the image is within a respective range). After which, the pixels having values in the respective ranges for a respective tile may be summed (e.g., adding post-mask values of 1 for a respective tile). The summed value may then be divided by the total number of pixels in the respective tile, converting into a percentage of the pixels of the respective color. In one or some embodiments, weighting of the ratios may occur thereafter. For example, given that the color brown may be more important than yellow or orange as indicative of dirt, the ratio of brown pixels in the respective tile may be weighted greater than the rations of yellow or orange (e.g., the ratio for brown is weighted as 50% of the total value while the ratios for orange and yellow are both weighted as 25% of the total value). In this way, the pixel chemistry analysis may indicate a chemical signature of the dust or dirt present on the solar panels.

At 378, pixel values may be analyzed, such as assigning a score per pixel with the higher the discoloration or lower the value in the range, the more the soiling. At 380, the scores are summed across all pixels in the solar panel to estimate the solar panel soiling index for a particular date in the timeline. At 382, this may be repeated for all solar panels for the same date. At 384, the procedure may be repeated for some or all dates. At 386, a deterioration pattern may be estimated based on the dominant wind direction and soiling history. At 388, a recommend cleaning sequence may be generated based on worst-best panel health index.

FIG. 4G is an example plot 470 of a soiling profile output 472 of the computer vision analysis predicting the soiling buildup fraction over a time period. As discussed above, the computer vision analysis for soiling buildup may be based on any one, any combination, or all of: pixel chemistry analysis; Kimber model analysis; or HSU model analysis.

In one or some embodiments, the soiling analysis may comprise the pixel chemistry analysis in combination with both the Kimber model and the HSU model. As discussed above, the Kimber model is configured to confirm soiling whereas the HSU model is configured to confirm a decrease in performance. Further, the Kimber model and the HSU model are physics-based models that may accommodate manual washing and rainfall (e.g., in the Kimber model, 20 mm of rain is sufficient for cleaning the panels entirely without any manual intervention). In this regard, the physics-based models, such as one or both of the Kimber model and the HSU model, may complement the pixel chemistry analysis.

The computer vision analysis may thus be used for one or both of: a retrospective analysis (e.g., determining the soiling buildup fraction in the past); and a prospective analysis (e.g., determining the soiling buildup fraction in the future). In one or some embodiments, the retrospective analysis may be compared with the actual soiling that has already occurred in order to improve the pixel chemistry analysis. In one or some embodiments, the prospective analysis may be used in order to determine whether and/or when to perform solar panel cleaning (such as automatic solar panel cleaning).

Referring back to FIG. 4G, the plot 470 indicates how the soiling has changed over time (e.g., up to December 2022) and how the soiling is predicted to change (e.g., January 2023 and beyond). Predictions of soiling may be based on any one, any combination, or all of: the wind direction; precipitation levels; or tilting angles. For example, the plot 470 indicates that soiling is estimated to decrease between January 2023 and February 2023 due to potential rainfall (though not enough to remove all of the dirt). As shown, the soiling profile output 472 for March 2023 projects an 0.8% overall soiling, indicating that there is a need to clean the solar panels (e.g., a predicted amount greater than 0.6% indicates a need to clean; alternatively, a predicted amount greater than 0.6% for at least two months (or other predetermined time period) triggers a clean). Thus, in one embodiment, a static threshold (e.g., 0.6%) may be used to determine whether to clean. Alternatively, a dynamic threshold may be used, such as based on trends in one or both of soiling (e.g., soiling is increasing) or transmission index (e.g., transmission index is increasing). However, the soiling profile output 472 may not indicate which solar panels to clean. In this regard, the soiling model may analyze one or more conditions such as any one, any combination, or all of: (1) the soiling model indicating that the soiling value is greater than 0; (2) the soiling model predicts that the soiling will continue; or (3) the soiling model predicts a trend of decreasing performance of the solar farm (e.g., soiling is increasing). With any one, any combination, or all of the three conditions, the cleaning sequence, including when, which solar panels, and what priority, may be performed.

FIG. 4H is an example illustration 480 indicating a sequence of cleaning solar panels. As discussed above, responsive to determining to clean the solar panels, the system may determine any one, any combination, or all of: a listing of solar panels to clean (including an identification of the solar panels to clean and/or a location (e.g., latitude/longitude) of the solar panels to clean); a sequence of the solar panels to clean; or a timing (in the sequence) of the solar panels to clean. As shown in FIG. 4H, a map or other underlying image identifying the solar farm may be modified, such as incorporating therein, overlaying thereon, or the like, with additional information, such as the listing of solar panels to clean; the sequence of the solar panels to clean; or the timing of the solar panels to clean. By way of example, the image (after modification) may include one or more icons, pins, or the like 481, 482, 483, 484 indicating information regarding the solar panels subject to cleaning. Along with the icons, pins, or the like 481, 482, 483, 484, information may be presented including the sequence and/or timing of cleaning. As one example, clicking on the icon, pin, or the like 481, 482, 483, 484 may result in information in a pop-up window being presented, such as the latitude/longitude of the respective solar panel and/or the sequence of cleaning and/or timing of cleaning. As another example, the information may be presented along with icon, pin, or the like 481, 482, 483, 484, such as shown in FIG. 4H in which the sequence of cleaning, indicated by 2, 5, 6, 7, 8, 9, may be presented in combination with the icon, pin, or the like 481, 482, 483, 484. In one or some embodiments, the output represented in FIG. 4H may be sent to an operator in order to control cleaning (e.g., to command a mechanical cleaner or to clean the solar panels manually). Alternatively, the information represented in FIG. 4H may be sent to an automatic solar panel cleaning system to automatically perform the solar panel cleaning.

In all practical applications, the present technological advancement must be used in conjunction with a computer, programmed in accordance with the disclosures herein. Merely by way of example, various devices disclosed in the present application may comprise a computer or may work in combination with a computer (e.g., executed by a computer), such as, for example, in block diagram in FIG. 10r in flow diagrams 2 and 3A-D. Merely by way of example, computing functionality may be manifested in computer vision 110, panel detection methodology 114, shading detection methodology 116, soiling detection methodology 118, determined actions based on determined shading 120, determined actions based on: (i) determined shading and (ii) determined and/or predicted soiling 122, determined actions based on determined soiling 124, electronic device(s) to perform the determined actions based on determined shading 130, electronic device(s) to perform the determined actions based on both: (i) determined shading and (ii) determined and/or predicted soiling 132, or electronic device(s) to perform the determined actions based on determined and/or predicted soiling 134. As such, computing functionality may be resident within any of the electronic devices discussed herein.

FIG. 5 is a diagram of an exemplary computer system 500 that may be utilized to implement methods, including the flow diagrams, described herein. A central processing unit (CPU) 502 is coupled to system bus 504. The CPU 502 may be any general-purpose CPU, although other types of architectures of CPU 502 (or other components of exemplary computer system 500) may be used as long as CPU 502 (and other components of computer system 500) supports the operations as described herein. Those of ordinary skill in the art will appreciate that, while only a single CPU 502 is shown in FIG. 5, additional CPUs may be present. Moreover, the computer system 500 may comprise a networked, multi-processor computer system that may include a hybrid parallel CPU/GPU system. The CPU 502 may execute the various logical instructions according to various teachings disclosed herein. For example, the CPU 502 may execute machine-level instructions for performing processing according to the operational flow described herein.

The computer system 500 may also include computer components such as non-transitory, computer-readable media. Examples of computer-readable media include computer-readable non-transitory storage media, such as a random-access memory (RAM) 506, which may be SRAM, DRAM, SDRAM, or the like. The computer system 500 may also include additional non-transitory, computer-readable storage media such as a read-only memory (ROM) 508, which may be PROM, EPROM, EEPROM, or the like. RAM 506 and ROM 508 hold user and system data and programs, as is known in the art. In this regard, computer-readable media may comprise executable instructions to perform any one, any combination, or all of the blocks in the flow charts in FIGS. 3-5 and 7. The computer system 500 may also include an input/output (I/O) adapter 510, a graphics processing unit (GPU) 514, a communications adapter 522 (e.g., a communication interface), a user interface adapter 524, a display driver 516, and a display adapter 518.

The I/O adapter 510 may connect additional non-transitory, computer-readable media such as storage device(s) 512, including, for example, a hard drive, a compact disc (CD) drive, a floppy disk drive, a tape drive, and the like to computer system 500. The storage device(s) may be used when RAM 506 is insufficient for the memory requirements associated with storing data for operations of the present techniques. The data storage of the computer system 500 may be used for storing information and/or other data used or generated as disclosed herein. For example, storage device(s) 512 may be used to store configuration information or additional plug-ins in accordance with the present techniques. Further, user interface adapter 524 couples user input devices, such as a keyboard 528, a pointing device 526 and/or output devices to the computer system 500. The display adapter 518 is driven by the CPU 502 to control the display on a display device 520 to, for example, present information to the user such as images generated according to methods described herein.

The architecture of computer system 500 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 500 may include various plug-ins and library files. Input data may additionally include configuration information.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting models discussed herein may be downloaded or saved to computer storage.

The following example embodiments of the invention are also disclosed:

### Embodiment 1

A computer-implemented method for increasing power generated by solar panels in a solar farm, the method comprising:
accessing at least one image that includes the solar panels in the solar farm;
determining at least one visual aspect of one or both of an environment of the solar farm or of the solar panels;
using the at least one aspect of one or both of an environment of the solar farm or of the solar panels in order to perform one or both of: (i) masking of the at least one image; or (ii) analyzing the at least one image in order to determine one or both of soiling on or shading of the solar panels; and
performing one or both of:
   generating an output image in order to identify or indicate the one or both of the soiling on or the shading of the solar panels; or
   automatically performing at least one action in order to reduce the soiling on or the shading on the solar panels.

### Embodiment 2

The method of embodiment 1:
wherein the at least one visual aspect comprises at least one aspect of sunlight.

### Embodiment 3

The method of embodiments 1 or 2:
wherein the at least one aspect of sunlight comprises reflectance of the sunlight.

### Embodiment 4

The method of any of embodiments 1-3:
wherein the reflectance of the sunlight comprises albedo.

### Embodiment 5

The method of any of embodiments 1-4:
wherein, for both determining the soiling and determining the shading, one or both of the following is performed in combination: the masking of the at least one image or the analyzing the at least one image.

### Embodiment 6

The method of any of embodiments 1-5:
wherein a same visual aspect is used for determining both the soiling on and the shading of the solar panels.

### Embodiment 7

The method of any of embodiments 1-6:
wherein masking of the at least one image is performed in combination for both determining the soiling and determining the shading.

### Embodiment 8

The method of any of embodiments 1-7:
wherein a first masking for the at least one image is performed based on a same visual aspect for determining the soiling; and
wherein a second masking for the at least one image is performed based on the same visual aspect for determining the shading.

### Embodiment 9

The method of any of embodiments 1-8:
wherein analyzing of the at least one image is performed in combination for both determining the soiling and determining the shading.

### Embodiment 10

The method of any of embodiments 1-9:
wherein pixel analysis for the at least one image is performed based on a same visual aspect for determining the soiling; and
wherein the pixel analysis for the at least one image is performed based on the same visual aspect for determining the shading.

### Embodiment 11

The method of any of embodiments 1-10:
wherein the at least one aspect is used for determining both the soiling on and the shading of the solar panels.

### Embodiment 12

The method of any of embodiments 1-11:
wherein the at least one aspect is used for both: (i) masking of the at least one image; and (ii) analyzing the at least one image in order to determine both soiling on and shading of the solar panels.

### Embodiment 13

The method of any of embodiments 1-12:
wherein analyzing the at least one image in order to determine soiling on the solar panels comprises performing pixel-based analysis on the at least one image in order to determine the soiling on the solar panels and to determine the shading on the solar panels.

### Embodiment 14

The method of any of embodiments 1-13:
wherein analyzing the at least one image in order to determine soiling on the solar panels further comprises analyzing pixel distributions for shading and for soiling in order to determine soiling and shading respectively.

### Embodiment 15

The method of any of embodiments 1-14:
wherein skewness of the pixel distributions are analyzed to determine whether shading and soiling are increasing.

### Embodiment 16

The method of any of embodiments 1-15: further comprising power analysis to determine whether to perform one or more corrective actions to reduce one or both of soiling or shading.

### Embodiment 17

The method of any of embodiments 1-16:
wherein the power analysis comprises analyzing power blocks for the solar farm; and
wherein the power blocks correlate power generated with estimated soiling and estimated shading.

### Embodiment 18

The method of any of embodiments 1-17:
wherein the power analysis outputs an indication whether soiling or shading for a respective power block contributes more to power loss.

### Embodiment 19

The method of any of embodiments 1-18:
wherein the at least one image comprises one or more clipped images from an underlying image; and
wherein the one or more clipped images are clipped based on the at least one aspect of the one or both of an environment of the solar farm or of the solar panels.

### Embodiment 20

A computer-implemented method for increasing power generated by solar panels in a solar farm, the method comprising:
accessing at least one image that includes the solar panels in the solar farm; and
performing in combination one or more of:
masking prior to soiling analysis and masking prior to shading analysis in combination;
performing the soiling analysis and the shading analysis in combination; or
power analysis to determine power loss due to soiling and shading in combination.

### Embodiment 21

The method of embodiment 20:
wherein at least two of the following are performed in combination:
the masking prior to soiling analysis and masking prior to shading analysis in combination;
the performing of the soiling analysis and the shading analysis in combination; or
the power analysis to determine power loss due to soiling and shading in combination.

### Embodiment 22

The method of embodiments 20 or 21:
wherein the following is performed based on a common visual metric:
the masking prior to soiling analysis and masking prior to shading analysis in combination; and
the performing of the soiling analysis and the shading analysis in combination

### Embodiment 23

The method of any of embodiments 20-22:
wherein all of the following are performed in combination:
the masking prior to soiling analysis and masking prior to shading analysis in combination;
the performing of the soiling analysis and the shading analysis in combination; and
the power analysis to determine power loss due to soiling and shading in combination.

### Embodiment 24

A method of reducing shading on solar panels in a solar farm, the method comprising:
identifying the solar panels in the solar farm within at least one image based on one or both of geometric analysis or pixel-based analysis of the at least one image;
identifying shading on the solar panels by:
   iteratively performing the pixel-based analysis on at least two different types of images; and
   determining the shading on the solar panels based on the iterative analysis; and performing one or both of:
   modifying an output image in order to identify the determined shading on the solar panels; or
   automatically performing at least one action in order to reduce the shading on the solar panels.

### Embodiment 25

The method of embodiment 24:
wherein iteratively performing the pixel-based analysis on the at least two different types of images comprises iteratively performing the pixel-based analysis on at least one visual range satellite image and on at least one non-visual range satellite image.

### Embodiment 26

The method of embodiments 24 or 25:
wherein the at least one non-visual range satellite image comprises at least one surface reflectance satellite image.

### Embodiment 27

The method of any of embodiments 24-26:
wherein iteratively performing the pixel-based analysis on the at least one visual range satellite image and on the at least one surface reflectance satellite image generates a lower bound of shading and an upper bound of shading; and
wherein the shading on the solar panels is determined based on the lower bound of shading and the upper bound of shading.

### Embodiment 28

The method of any of embodiments 24-27:
wherein the solar panels are identified based on both of the geometric analysis of the at least one image and the pixel-based analysis of the at least one image; and
wherein the geometric analysis detects contours, edges and corners in order to identify the solar panels.

### Embodiment 29

The method of any of embodiments 24-28:
wherein identifying the shading on the solar panels distinguishes between a shaded solar panel and a clean solar panel based on clustering of pixel values in the at least two different types of images.

### Embodiment 30

A method of reducing soiling on solar panels in a solar farm, the method comprising:
identifying the solar panels in the solar farm within at least one image based on one or both of geometric analysis or pixel-based analysis of the at least one image;
performing pixel-based analysis on the at least one image in order to determine soiling on the solar panels;
determining one or both of whether to clean at least some of the solar panels or which of the solar panels to clean based on both the pixel-based analysis and a non-pixel-based analysis; and
performing one or both of:
   modifying an output image in order to identify which of the solar panels to clean; or
   automatically performing at least one action in order to clean one or more of the solar panels.

### Embodiment 31

The method of embodiment 30:
wherein the non-pixel-based analysis is based on at least one physics-based soiling model configured to indicate the soiling on the solar panels.

### Embodiment 32

The method of embodiments 30 or 31:
wherein the at least one physics-based soiling model comprises at least one of a Kimber model or a Humboldt State University (HSU) model.

### Embodiment 33

The method of any of embodiments 30-32:
wherein the non-pixel-based analysis is based on a wind direction indicator, the wind direction indicator indicative of wind direction at the solar farm;
wherein non-pixel-based analysis determines an axis that is prone to soiling; and
wherein the axis that is prone to soiling is used in combination with the pixel-based analysis to determine a sequence of automatically cleaning the one or more of the solar panels.

### Embodiment 34

The method of any of embodiments 30-33:
wherein the wind direction indicator comprises a wind rose.

### Embodiment 35

A method of performing shading analysis and soiling analysis of solar panels in a solar farm, the method comprising:
identifying the solar panels in the solar farm within at least one image based on one or both of geometric analysis or pixel-based analysis of the at least one image;
performing pixel-based analysis on the at least one image in order to determine shading on the solar panels;
performing the pixel-based analysis on the at least one image in order to determine soiling on the solar panels;
wherein the shading and the soiling are performed in combination to determine at least one aspect of the solar farm based on one or both of: the pixel-based analysis to determine the shading on the solar panels and to determine the soiling on the solar panels are performed in combination; or results from the pixel-based analysis to determine the shading on the solar panels and to determine the soiling on the solar panels are used in combination; and performing at least one action based on the at least one aspect of the solar farm.

### Embodiment 36

The method of embodiment 35:
wherein the shading and the soiling are performed to determine performance of the solar farm.

### Embodiment 37

The method of embodiments 35 or 36:
further comprising:
   accessing an amount of power committed from the solar farm; and
   comparing the amount of power committed from the solar farm with the performance of the solar farm; and
   responsive to determining that the amount of power committed from the solar farm will not be met by the performance of the solar farm, determining whether modifying one or both of shading or soiling will increase the performance of the solar farm by at least a predetermined amount; and
wherein performing the at least one action is in response to determining that modifying one or both of shading or soiling will increase the performance of the solar farm by at least a predetermined amount.

### Embodiment 38

The method of any of embodiments 35-37:
wherein the pixel-based analysis to determine the shading on the solar panels and to determine the soiling on the solar panels are performed in combination.

### Embodiment 39

The method of any of embodiments 35-38:
wherein identifying the solar panels is common to both determining the shading and determining the soiling.

### Embodiment 40

The method of any of embodiments 35-39:
wherein the pixel-based analysis to determine the shading on the solar panels and the pixel-based analysis to determine the soiling on the solar panels contrast one another.

### Embodiment 41

The method of any of embodiments 35-40:
wherein values of pixels in performing the pixel-based analysis to determine the shading on the solar panels are mutually exclusive of other values in performing the pixel-based analysis to determine the soiling on the solar panels.

### Embodiment 42

The method of any of embodiments 35-41:
wherein the shading and the soiling are performed in combination to consider a both shaded and soiled solar panel.

### Embodiment 43

The method of any of embodiments 35-42:
wherein the shading and the soiling are performed in combination by performing the pixel-based analysis on at least two different types of images in order to determine a range of shading in at least a part of the solar farm.

### Embodiment 44

A system comprising:
a processor; and
a non-transitory machine-readable medium comprising instructions that, when executed by the processor, cause a computing system to perform a method according to embodiments 24-29.

### Embodiment 45

a non-transitory machine-readable medium comprising instructions that, when executed by the processor, cause a computing system to perform a method according to embodiments 24-29.

### Embodiment 46

A system comprising:
a processor; and
a non-transitory machine-readable medium comprising instructions that, when executed by the processor, cause a computing system to perform a method according to embodiments 1-19.

### Embodiment 47

A system comprising:
a processor; and
a non-transitory machine-readable medium comprising instructions that, when executed by the processor, cause a computing system to perform a method according to embodiments 20-23.

### Embodiment 48

a non-transitory machine-readable medium comprising instructions that, when executed by the processor, cause a computing system to perform a method according to embodiments 1-19.

### Embodiment 49

a non-transitory machine-readable medium comprising instructions that, when executed by the processor, cause a computing system to perform a method according to embodiments 20-23.

### Embodiment 50

A system comprising:
a processor; and
a non-transitory machine-readable medium comprising instructions that, when executed by the processor, cause a computing system to perform a method according to embodiments 30-44.

### Embodiment 51

a non-transitory machine-readable medium comprising instructions that, when executed by the processor, cause a computing system to perform a method according to embodiments 30-44.

### Embodiment 52

A system comprising:
a processor; and
a non-transitory machine-readable medium comprising instructions that, when executed by the processor, cause a computing system to perform a method according to embodiments 35-43.

### Embodiment 53

a non-transitory machine-readable medium comprising instructions that, when executed by the processor, cause a computing system to perform a method according to embodiments 35-43.

### Embodiment 54

An apparatus configured to reduce shading on solar panels in a solar farm, the apparatus comprising:
at least one communication interface configured to receive at least one image; and
at least one processor in communication with the at least one communication interface and configured to:
   identify the solar panels in the solar farm within the at least one image based on one or both of geometric analysis or pixel-based analysis of the at least one image;
   identify shading on the solar panels by:
      iteratively perform the pixel-based analysis on at least two different types of images; and
      determine the shading on the solar panels based on the iterative analysis; and
   perform one or both of:
      modifying an output image in order to identify the determined shading on the solar panels; or
      automatically perform, by transmitting one or more commands to an external electronic device, at least one action in order to reduce the shading on the solar panels.

### Embodiment 55

An apparatus configured to reduce soiling on solar panels in a solar farm, the apparatus comprising:
at least one communication interface configured to receive at least one image; and
at least one processor in communication with the at least one communication interface and configured to:
   identify the solar panels in the solar farm within the at least one image based on one or both of geometric analysis or pixel-based analysis of the at least one image;
   perform pixel-based analysis on the at least one image in order to determine soiling on the solar panels;
   determine one or both of whether to clean at least some of the solar panels or which of the solar panels to clean based on both the pixel-based analysis and a non-pixel-based analysis; and
   perform one or both of:
      modify an output image in order to identify which of the solar panels to clean; or
      automatically perform, by transmitting one or more commands to an external electronic device, at least one action in order to clean one or more of the solar panels.

### Embodiment 56

An apparatus configured to perform shading analysis and soiling analysis of solar panels in a solar farm, the apparatus comprising:
at least one communication interface configured to receive at least one image; and
at least one processor in communication with the at least one communication interface and configured to:
   identify the solar panels in the solar farm within the at least one image based on one or both of geometric analysis or pixel-based analysis of the at least one image;
   perform pixel-based analysis on the at least one image in order to determine shading on the solar panels;
   perform the pixel-based analysis on the at least one image in order to determine soiling on the solar panels;
   wherein the shading and the soiling are performed in combination to determine at least one aspect of the solar farm based on one or both of: the pixel-based analysis to determine the shading on the solar panels and to determine the soiling on the solar panels are performed in combination; or results from the pixel-based analysis to determine the shading on the solar panels and to determine the soiling on the solar panels are used in combination; and
   perform, by transmitting one or more communications to an external electronic device, at least one action based on the at least one aspect of the solar farm.

What is claimed is:

1. A computer-implemented method for increasing power generated by solar panels in a solar farm, the method comprising:
accessing at least one image that includes the solar panels in the solar farm;
determining at least one visual aspect of one or both of an environment of the solar farm or of the solar panels;
using the at least one aspect of one or both of an environment of the solar farm or of the solar panels in order to perform one or both of: (i) masking of the at least one image; or (ii) analyzing the at least one image in order to determine one or both of soiling on or shading of the solar panels; and
performing one or both of:
generating an output image in order to identify or indicate the one or both of the soiling on or the shading of the solar panels; or
automatically performing at least one action in order to reduce the soiling on or the shading on the solar panels.

2. The method of claim 1, wherein the at least one visual aspect comprises at least one aspect of sunlight.

3. The method of claim 2, wherein the at least one aspect of sunlight comprises reflectance of the sunlight.

4. The method of claim 3, wherein the reflectance of the sunlight comprises albedo.

5. The method of claim 1, wherein, for both determining the soiling and determining the shading, one or both of the following is performed in combination: the masking of the at least one image or the analyzing the at least one image.

6. The method of claim 5, wherein a same visual aspect is used for determining both the soiling on and the shading of the solar panels.

7. The method of claim 5, wherein masking of the at least one image is performed in combination for both determining the soiling and determining the shading.

8. The method of claim 7, wherein a first masking for the at least one image is performed based on a same visual aspect for determining the soiling; and
wherein a second masking for the at least one image is performed based on the same visual aspect for determining the shading.

9. The method of claim 5, wherein analyzing of the at least one image is performed in combination for both determining the soiling and determining the shading.

10. The method of claim 9, wherein pixel analysis for the at least one image is performed based on a same visual aspect for determining the soiling; and
wherein the pixel analysis for the at least one image is performed based on the same visual aspect for determining the shading.

11. The method of claim 1, wherein the at least one aspect is used for determining both the soiling on and the shading of the solar panels.

12. The method of claim 11, wherein the at least one aspect is used for both: (i) masking of the at least one image; and (ii) analyzing the at least one image in order to determine both soiling on and shading of the solar panels.

13. The method of claim 12, wherein analyzing the at least one image in order to determine soiling on the solar panels comprises performing pixel-based analysis on the at least one image in order to determine the soiling on the solar panels and to determine the shading on the solar panels.

14. The method of claim 13, wherein analyzing the at least one image in order to determine soiling on the solar panels further comprises analyzing pixel distributions for shading and for soiling in order to determine soiling and shading respectively.

15. The method of claim 14, wherein skewness of the pixel distributions are analyzed to determine whether shading and soiling are increasing.

16. The method of claim 13, further comprising power analysis to determine whether to perform one or more corrective actions to reduce one or both of soiling or shading.

17. The method of claim 16, wherein the power analysis comprises analyzing power blocks for the solar farm; and
wherein the power blocks correlate power generated with estimated soiling and estimated shading.

18. The method of claim 17, wherein the power analysis outputs an indication whether soiling or shading for a respective power block contributes more to power loss.

19. The method of claim 1, wherein the at least one image comprises one or more clipped images from an underlying image; and
wherein the one or more clipped images are clipped based on the at least one aspect of the one or both of an environment of the solar farm or of the solar panels.

20. A computer-implemented method for increasing power generated by solar panels in a solar farm, the method comprising:
accessing at least one image that includes the solar panels in the solar farm; and
performing in combination one or more of:
masking prior to soiling analysis and masking prior to shading analysis in combination;
performing the soiling analysis and the shading analysis in combination; or
power analysis to determine power loss due to soiling and shading in combination.

21. The method of claim 20, wherein at least two of the following are performed in combination:
the masking prior to soiling analysis and masking prior to shading analysis in combination;
the performing of the soiling analysis and the shading analysis in combination; or
the power analysis to determine power loss due to soiling and shading in combination.

22. The method of claim 21, wherein the following is performed based on a common visual metric:
the masking prior to soiling analysis and masking prior to shading analysis in combination; and
the performing of the soiling analysis and the shading analysis in combination.

23. The method of claim 20, wherein all of the following are performed in combination:
the masking prior to soiling analysis and masking prior to shading analysis in combination;
the performing of the soiling analysis and the shading analysis in combination; and
the power analysis to determine power loss due to soiling and shading in combination.
